(19) United States
(12) Patent Application Publication
(10) Pub. No.: US 2025/0322779 A1
(43) Pub. Date: Oct. 16, 2025

(54) DISPLAY DRIVER CIRCUIT, CONTROL METHOD FOR DISPLAY DRIVER CIRCUIT, DISPLAY MODULE, AND ELECTRONIC DEVICE

(71) Applicant: HUAWEI TECHNOLOGIES CO., LTD., Shenzhen (CN)

(72) Inventors: Qinren YAO, Shanghai (CN); Wei Hsiang HUNG, Shenzhen (CN); Bei LI, Shenzhen (CN); Chuan Che LEE, Shenzhen (CN); Shengchao WANG, Shenzhen (CN)

(21) Appl. No.: 19/251,948

(22) Filed: Jun. 27, 2025

Related U.S. Application Data
(63) Continuation of application No. PCT/CN2023/121078, filed on Sep. 25, 2023.

(30) Foreign Application Priority Data
Dec. 29, 2022 (CN) 202211708605.7

(51) Int. Cl. G09G 3/20

(52) U.S. Cl. CPC G09G 3/2092; G09G 2320/0276; G09G 2330/021

(57) ABSTRACT

Embodiments of this application provide a display driver circuit, a control method for a display driver circuit, a display module, and an electronic device, and relate to the field of display technologies, to resolve a problem that an over-designed driver circuit cannot meet a low power consumption requirement. The display driver circuit is used in a display module, and may include at least one dynamic bias generator, a plurality of gamma operational amplifiers, a resistor string, and a plurality of source driving channels. The dynamic bias generator is configured to output a dynamically adjustable bias current. At least one of the plurality of gamma operational amplifiers may be electrically connected to the dynamic bias generator, and the gamma operational amplifier is configured to output a gamma reference voltage based on the bias current. The resistor string performs voltage division on output terminals of two adjacent gamma operational amplifiers.

### CROSS-REFERENCE TO RELATED APPLICATION

This application is a continuation of International Application No. PCT/CN2023/121078, filed on Sep. 25, 2023, which claims priority to Chinese Patent Application No. 202211708605.7, filed on Dec. 29, 2022. The disclosures of the aforementioned applications are hereby incorporated by reference in their entireties.

### TECHNICAL FIELD

This application relates to the field of display technologies, and in particular, to a display driver circuit, a control method for a display driver circuit, a display module, and an electronic device.

### BACKGROUND

With continuous development of display technologies, an increasing quantity of electronic devices have display functions. A display panel of the electronic device includes a small display unit, namely, a subpixel (subpixel). A grayscale and a color of each subpixel may be controlled to enable the entire display panel to display a preset picture.

A driver circuit in the electronic device can drive the subpixel for display. However, when the driver circuit is heavily loaded, stability and thrust of the driver circuit are reduced. To improve the stability and the thrust of the driver circuit, the driver circuit is usually over-designed to meet a heavy load requirement. This results in an increase in power consumption of the driver circuit.

### SUMMARY

This application provides a display driver circuit, a control method for a display driver circuit, a display module, and an electronic device, to resolve a problem that an over-designed driver circuit cannot meet a low power consumption requirement.

To achieve the foregoing objective, the following technical solutions are used in this application.

According to an aspect of this application, a display driver circuit used in a display module is provided. The display driver circuit may include at least one dynamic bias generator, a plurality of gamma operational amplifiers, a resistor string, and a plurality of source driving channels. The dynamic bias generator is configured to output a dynamically adjustable bias voltage. At least one of the plurality of gamma operational amplifiers may be electrically connected to the dynamic bias generator, and the gamma operational amplifier is configured to output a gamma reference voltage based on the bias current. On this basis, the resistor string is electrically connected to output terminals of N gamma operational amplifiers, and the resistor string may be configured to perform voltage division on output terminals of two adjacent gamma operational amplifiers. The plurality of source driving channels are electrically connected to the resistor string. In conclusion, when the gamma operational amplifier is in a heavy-load state, the dynamic bias generator may provide a high bias voltage to the gamma operational amplifier electrically connected to the dynamic bias generator, so that the gamma operational amplifier has good stability and thrust. Alternatively, when the gamma operational amplifier electrically connected to the dynamic bias generator is in a light-load state, the dynamic bias generator may provide a low bias voltage to the gamma operational amplifier. This can help reduce power consumption of the gamma operational amplifier. On this basis, the resistor string provides a voltage to the source driving channel through voltage division, so that the source driving channel can drive a subpixel for display. It may be learned from the foregoing descriptions that the gamma operational amplifier in the display driver circuit provided in this embodiment of this application may receive a dynamically adjustable bias voltage based on a load condition. In this way, the gamma operational amplifier and the entire display driver circuit can have good stability and thrust without a need to over-design the gamma operational amplifier in a heavy-load condition, and the gamma operational amplifier and the entire display driver circuit have low power consumption in the light-load state.

In an optional implementation, the plurality of gamma operational amplifiers include a first gamma operational amplifier and a second gamma operational amplifier. The first gamma operational amplifier outputs an upper-limit gamma reference voltage Vg0, and the second gamma operational amplifier outputs a lower-limit gamma reference voltage Vgn. The dynamic bias generator is electrically connected to at least one of the first gamma operational amplifier and the second gamma operational amplifier. The upper-limit gamma reference voltage Vg0 is used as a maximum value in a plurality of grayscale voltages, and the lower-limit gamma reference voltage Vgn is used as a minimum value in the plurality of grayscale voltages. When grayscales of current rows of display signals of a same column of subpixels are a minimum grayscale, and grayscales of next rows of display signals are a maximum grayscale, the second gamma operational amplifier needs to provide the lower-limit gamma reference voltage Vgn to each subpixel in a plurality of columns of subpixels, and a swing of a voltage difference ΔV between display signals of two adjacent subpixels in the same column is largest. Alternatively, when grayscales of current rows of display signals of most of subpixels in a same column of subpixels are a maximum grayscale, and grayscales of next rows of display signals are a minimum grayscale, the first gamma operational amplifier needs to provide the upper-limit gamma reference voltage Vg0 to each of the plurality of subpixels, and a swing of a voltage difference ΔV between display signals of two adjacent subpixels in the same column is largest. In addition, the upper-limit gamma reference voltage Vg0 output by the first gamma operational amplifier is close to a first working voltage VDD, and a voltage value of the lower-limit gamma reference voltage Vgn output by the second gamma operational amplifier may be close to a second working voltage VSS. Therefore, input currents of the first gamma operational amplifier and the second gamma operational amplifier decrease, and an overall operational amplifier speed decreases. In this way, when the first gamma operational amplifier or the second gamma operational amplifier needs to drive all columns of subpixels, the first gamma operational amplifier or the second gamma operational amplifier is in an extreme heavy-load state, and stability and thrust of the first gamma operational amplifier or the second gamma operational amplifier are challenged. Therefore, the first gamma operational amplifier is electrically connected to the dynamic bias generator, to compensate the thrust and the stability of the first gamma operational amplifier in the heavy-load state, and reduce power consumption of the first gamma operational amplifier in the light-load state. Alternatively, the second gamma operational amplifier is electrically connected to the dynamic bias generator, to compensate the thrust and the stability of the second gamma operational amplifier in the heavy-load state, and reduce power consumption of the second gamma operational amplifier in the light-load state.

In an optional implementation, the at least one dynamic bias generator may include a first dynamic bias generator and a second dynamic bias generator. The first dynamic bias generator is electrically connected to the first gamma operational amplifier, and the first dynamic bias generator is configured to output a first bias current based on a first bias control signal. The second dynamic bias generator is electrically connected to the second gamma operational amplifier, and the second dynamic bias generator is configured to output a second bias current based on a second bias control signal. In this way, the thrust and the stability of the first gamma operational amplifier and the second gamma operational amplifier can be separately compensated, to improve accuracy of compensation. In addition, the plurality of gamma operational amplifiers include at least one third gamma operational amplifier, and a gamma reference voltage output by the third gamma operational amplifier is between the lower-limit gamma reference voltage Vgn and the upper-limit gamma reference voltage Vg0. A static bias generator is electrically connected to the third gamma operational amplifier. The third gamma operational amplifier rarely experiences the foregoing extreme heavy-load or extreme light-load condition. Therefore, the third gamma operational amplifier may be connected to the static bias generator, and the static bias generator can provide a constant bias voltage to the third gamma operational amplifier, to simplify the circuit.

In an optional implementation, the display driver circuit further includes a bias controller. The bias controller is electrically connected to the dynamic bias generator, and the bias controller is configured to output a bias control signal. The dynamic bias generator is configured to output the dynamically adjustable bias voltage based on the bias control signal. In this way, the bias controller can output, based on a load condition (light load or heavy load) of the gamma operational amplifier electrically connected to the dynamic bias generator, a bias control signal that matches the load condition, to dynamically adjust the bias voltage output by the dynamic bias generator.

In an optional implementation, the display driver circuit further includes a timing controller. The timing controller is electrically connected to the bias controller, and is configured to generate a display signal. The bias controller is configured to output the bias control signal based on the display signal. In this way, the timing controller can provide a display signal to the bias controller, so that the bias controller can learn of a load condition (light load or heavy load) of the gamma operational amplifier based on the display signal, and further the bias controller outputs a bias control signal that matches the load condition, to dynamically adjust the bias voltage output by the dynamic bias generator.

In an optional implementation, the dynamic bias generator includes a current source, a current mirror, and at least one first switching device. The current source is electrically connected between a first voltage terminal and a second voltage terminal, and the current source is configured to provide an initial current. The current mirror is electrically connected to the current source, the first voltage terminal, and the second voltage terminal. A control terminal of the first switching device is electrically connected to a second comparator circuit, a first terminal of the first switching device is electrically connected to the first voltage terminal, and a second terminal is electrically connected to the current mirror and an output terminal of the dynamic bias generator. In this way, the current source can provide a constant initial current to the current mirror. The current mirror may mirror the initial current provided by the current source to a branch in which the first switching device is located. An on/off state of the first switching device may be used to determine a value of total resistance between the first voltage terminal and the output terminal of the dynamic bias generator, and further used to determine a value of a voltage output by the output terminal of the dynamic bias generator and a value of a bias current provided to the gamma operational amplifier.

In an optional implementation, the bias controller may include a row delay circuit, a first comparator circuit, a counting circuit, and the second comparator circuit. The row delay circuit is configured to output a display signal delayed by one row. In this way, a next row of display signals in a frame of display image can be obtained through the row delay circuit. The first comparator circuit may be electrically connected to the row delay circuit, and the first comparator circuit is configured to compare a voltage of a current row of display signals and a voltage of a next row of display signals. In this way, a voltage change amplitude between two adjacent rows of display signals can be obtained through the first comparator circuit. The counting circuit may be electrically connected to the first comparator circuit, and is configured to count a quantity of times a comparison result from the first comparator circuit is received. In addition, the second comparator circuit may be electrically connected to the counting circuit, and is configured to: compare a counting result from the counting circuit with a preset counting threshold, and output the bias control signal. In this way, the second comparator circuit can compare the counting result from the counting circuit with the preset counting threshold, to learn whether the gamma operational amplifier is in the heavy-load state or the light-load state, so that the bias control signal output by the bias controller matches the load state of the gamma operational amplifier, to compensate stability and thrust of the gamma operational amplifier based on the load state of the gamma operational amplifier, or reduce power consumption. A value of a preset voltage threshold may be coordinated with a value of the preset counting threshold, so that when a voltage difference ΔV between two adjacent rows of display signals reaches the preset voltage threshold, and the counting result reaches the preset counting threshold, the stability and the thrust of the gamma operational amplifier working in the heavy-load state are up to a limit, and a display effect of an electronic device is a poorest acceptable display effect.

According to another aspect of this application, a control method for a display driver circuit is provided. The display driver circuit includes at least one dynamic bias generator, a plurality of gamma operational amplifiers, a resistor string, and a source driving channel. At least one of the plurality of gamma operational amplifiers is electrically connected to the dynamic bias generator. The resistor string is electrically connected to output terminals of the plurality of gamma operational amplifiers, and is configured to output a plurality of grayscale voltages. The source driving channel is electrically connected to the resistor string. The control method includes: first, controlling the dynamic bias generator to output a dynamically adjustable bias voltage; then, controlling the gamma operational amplifier to output a gamma reference voltage based on the bias voltage; and then, controlling the source driving channel to generate a voltage based on the grayscale voltage. The control method for a display driver circuit has same technical effects as the display driver circuit provided in the foregoing embodiment. Details are not described herein.

In an optional implementation, before controlling the dynamic bias generator to output the dynamically adjustable bias voltage, the method includes: first, comparing a voltage of a current row of display signals and a voltage of a next row of display signals that are in a same column, and if a voltage difference between the two adjacent rows of display signals is greater than or equal to a preset voltage threshold, outputting a comparison result; then, counting a quantity of times the comparison result is received, and outputting a counting result; and then, comparing the counting result with a preset counting threshold, and if the counting result is greater than or equal to the preset counting threshold, generating a bias control signal. In addition, controlling the dynamic bias generator to output the dynamically adjustable bias voltage includes: controlling the dynamic bias generator to output the dynamically adjustable bias voltage based on the bias control signal. In this way, the counting result from a counting circuit is compared with the preset counting threshold, to learn whether the gamma operational amplifier is in a heavy-load state or a light-load state, so that the bias control signal matches the load state of the gamma operational amplifier, to compensate stability and thrust of the gamma operational amplifier based on the load state of the gamma operational amplifier, or reduce power consumption.

In an optional implementation, the at least one dynamic bias generator includes a first dynamic bias generator and a second dynamic bias generator. The plurality of gamma operational amplifiers include a first gamma operational amplifier and a second gamma operational amplifier. The first gamma operational amplifier outputs an upper-limit gamma reference voltage Vg0, and the second gamma operational amplifier outputs a lower-limit gamma reference voltage Vgn. The first dynamic bias generator is electrically connected to the first gamma operational amplifier. The second dynamic bias generator is electrically connected to the second gamma operational amplifier. Based on this, comparing the voltage of the current row of display signals and the voltage of the next row of display signals that are in the same column, and if the voltage difference between the two adjacent rows of display signals is greater than or equal to the preset voltage threshold, outputting the comparison result includes: comparing the voltage of the current row of display signals and the voltage of the next row of display signals that are in the same column; and if the voltage of the current row of display signals is less than the voltage of the next row of display signals, and the voltage difference between the two adjacent rows of display signals is greater than or equal to the preset voltage threshold, outputting a first comparison result; or if the voltage of the current row of display signals is greater than the voltage of the next row of display signals, and the voltage difference between the two adjacent rows of display signals is greater than or equal to the preset voltage threshold, outputting a second comparison result. In addition, counting the quantity of times the comparison result is received, and outputting the counting result includes: counting a quantity of times the first comparison result is received, and outputting a first counting result; and counting a quantity of times the second comparison result is received, and outputting a second counting result. In addition, comparing the counting result with the preset counting threshold, and if the counting result is greater than or equal to the preset counting threshold, generating the bias control signal includes: comparing the first counting result with a first preset counting threshold, and if the first counting result is greater than or equal to the first preset counting threshold, outputting a first bias control signal; and comparing the second counting result with a second preset counting threshold, and if the second counting result is greater than or equal to the second preset counting threshold, outputting a second bias control signal. In addition, controlling the dynamic bias generator to output the dynamically adjustable bias voltage based on the bias control signal includes: controlling the first dynamic bias generator to output a first bias voltage to the first gamma operational amplifier based on the first bias control signal; and controlling the second dynamic bias generator to output a second bias voltage to the second gamma operational amplifier based on the second bias control signal. In this way, thrust and stability of the first gamma operational amplifier and the second gamma operational amplifier can be separately compensated, to improve accuracy of compensation.

In an optional implementation, comparing the counting result with the preset counting threshold, and if the counting result is greater than or equal to the preset counting threshold, generating the bias control signal includes: first, obtaining a counting threshold set, where the counting threshold set includes a plurality of to-be-selected thresholds that increase successively, and a counting threshold range is formed between every two adjacent to-be-selected thresholds; then, obtaining a minimum value of the counting threshold range as the preset counting threshold, comparing the counting result with the preset counting threshold, and determining, based on a comparison result, a counting threshold range within which the counting result falls; then, obtaining a bias control signal set, where the bias control signal set includes a plurality of different to-be-selected bias control signals, and each to-be-selected bias control signal matches one counting threshold range; and then, selecting a to-be-selected bias control signal that matches the counting threshold range within which the counting result falls from the bias control signal set as the bias control signal based on the counting threshold range. In this case, a plurality of preset counting thresholds are set, so that bias control signals that match different preset counting thresholds can be selected based on the preset counting thresholds. In this way, in the dynamic bias generator controlled by using different bias control signals, different quantities of a plurality of first switching devices are turned on and off, so that the dynamic bias generator can output a plurality of bias currents that match the different bias control signals, to finally improve accuracy of controlling the bias current.

In an optional implementation, a maximum value of the preset counting threshold is the same as a quantity of columns of the display signal. When voltage change amplitudes between two adjacent rows of display signals output by all columns of subpixels are large, the gamma operational amplifier is in an extreme heavy-load state. Therefore, the maximum value of the preset counting threshold is set to be the same as the quantity of columns of the display signal, so that setting of the preset counting threshold can match the extreme load state of the gamma operational amplifier.

According to another aspect of this application, a display module is provided. The display module may include a display panel and any one of the display driver circuits described above. The display panel includes a plurality of data lines, and the data line is electrically connected to a source driving channel in the display driver circuit. The display module has same technical effects as the display driver circuit provided in the foregoing embodiment. Details are not described herein.

According to another aspect of this application, an electronic device is provided. The electronic device includes a processor and the display module described above. The electronic device has same technical effects as the display driver circuit provided in the foregoing embodiment. Details are not described herein.

### BRIEF DESCRIPTION OF DRAWINGS

FIG. 1 is a diagram of a structure of an electronic device according to an embodiment of this application;

FIG. 2 is a diagram of a structure of a display module in FIG. 1;

FIG. 3 is a diagram of a structure of a display driver circuit in FIG. 2;

FIG. 4A is a diagram of a structure of a source driving channel in FIG. 3;

FIG. 4B is a waveform diagram of a clock signal in FIG. 4A;

FIG. 5 is a diagram of a structure of a display driver circuit according to an embodiment of this application;

FIG. 6 is a partial circuit diagram of an input stage of a gamma operational amplifier according to an embodiment of this application;

FIG. 7A is another diagram of a structure of a display driver circuit according to an embodiment of this application;

FIG. 7B is another diagram of a structure of a display driver circuit according to an embodiment of this application;

FIG. 7C is another diagram of a structure of a display driver circuit according to an embodiment of this application;

FIG. 7D is another diagram of a structure of a display driver circuit according to an embodiment of this application;

FIG. 7E is another diagram of a structure of a display driver circuit according to an embodiment of this application;

FIG. 8A is a flowchart of a control method for a display driver circuit according to an embodiment of this application;

FIG. 8B is a flowchart of another control method for a display driver circuit according to an embodiment of this application;

FIG. 9 is a diagram of a structure of a bias controller according to an embodiment of this application;

FIG. 10A is a flowchart of another control method for a display driver circuit another according to an embodiment of this application;

FIG. 10B-1 and FIG. 10B-2 are a flowchart of another control method for a display driver circuit according to an embodiment of this application;

FIG. 11A is a diagram of a structure of a dynamic bias generator according to an embodiment of this application;

FIG. 11B is another diagram of a structure of a dynamic bias generator according to an embodiment of this application; and

FIG. 12 is a flowchart of another control method for a display driver circuit according to an embodiment of this application.

### REFERENCE NUMERALS

01: Electronic device; 100: Display module; 101: Middle frame; 102: Rear housing; 10: Subpixel; 200: Display driver circuit; 20: Image processor; 21: Timing controller; 22: Grayscale control circuit; 23: Source driver circuit; 24: Gate driver circuit; 201: Display; 220: Resistor string; 230: Source driving channel; 2300: Shift register; 2301: Latch; 2302: Level converter; 2303: Digital-to-analog converter; 2034: Output voltage driver; 221: Bias controller; 222: Dynamic bias generator; 222a: First dynamic bias voltage generator; 222b: Second dynamic bias voltage generator; 2222: Static bias voltage generator; 2210: Row delay circuit; 2211: First comparator circuit; 2212: Counting circuit; 2213: Second comparator circuit; 2220: Current source; and 2221: Current mirror.

### DESCRIPTION OF EMBODIMENTS

The following describes the technical solutions in embodiments of this application with reference to the accompanying drawings in embodiments of this application. It is clear that the described embodiments are merely some but not all of embodiments of this application.

The following terms “first”, “second”, and the like are merely used for ease of description, and shall not be understood as an indication or implication of relative importance or an implicit indication of a quantity of indicated technical features. Therefore, a feature limited by “first”, “second”, or the like may explicitly or implicitly include one or more features. In the descriptions of this application, unless otherwise specified, “a plurality of” means two or more.

In this application, unless otherwise expressly specified and limited, the term “connection” should be understood in a broad sense. For example, the “connection” may be a fixed connection, or may be a detachable connection or an integrated connection; and may be a direct connection, or may be an indirect connection through an intermediate medium. In addition, an “electrical connection” may be a direct electrical connection, or an indirect electrical connection implemented through an intermediate medium. An electrical signal can be transmitted between electrically connected parts in a wired or wireless manner.

An embodiment of this application provides an electronic device. The electronic device may have the display function. The electronic device may be applied to various communication systems or communication protocols, for example, a global system for mobile communications (GSM), a code division multiple access (CDMA) system, wideband code division multiple access (WCDMA), a general packet radio service (GPRS), long term evolution (LTE), and the like. The electronic device may include a mobile phone (mobile phone), a tablet computer (pad), a television, a smart wearable product (for example, a smartwatch or a smart band), a virtual reality (VR) electronic device, an augmented reality (AR) electronic device, or the like. A specific form of the electronic device is not specially limited in embodiments of this application.

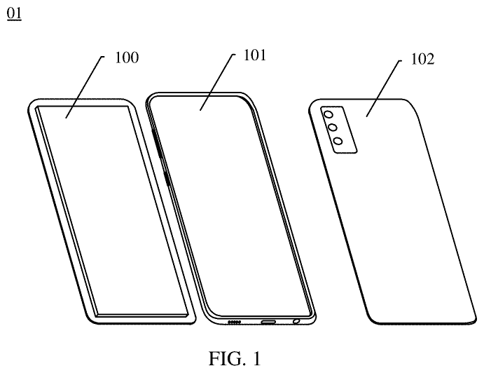

In some embodiments, to enable the electronic device to implement the display function, as shown in FIG. 1, an electronic device 01 provided in this embodiment of this application may include a display module 100, a rear housing 102 located on a back surface (disposed opposite to a display surface of the display module 100) of the display module 100, and a middle frame 101 located between the display module 100 and the rear housing 102. The middle frame 101 can support the display module 100.

The electronic device 01 may further include a processor electrically connected to the display module 100. The processor may be disposed on a side that is of the middle frame 101 and that is far away from the display module 100. The rear housing 102 is snapped onto the middle frame 101, so that mounting space is formed between the rear housing 102 and the middle frame 101, to accommodate the processor, a battery, and another component. The processor may provide a display signal to the display module 100, to drive the display module 100 to display an image. For example, the processor may include one or more processing units. For example, the processor may include an application processor (AP), a modem processor, a graphics processing unit (GPU), an image signal processor (ISP), a controller, a video codec, a digital signal processor (DSP), a baseband processor, a neural-network processing unit (NPU), and/or the like. Different processing units may be independent components, or may be integrated into one or more processors.

In addition, the electronic device 01 may further include a gyroscope (gyroscope) sensor, a Hall sensor (Hall sensor), an external memory interface, an internal memory, a universal serial bus (USB) port, a charging management module, a power management module, a battery, an antenna, a mobile communication module, a wireless communication module, an audio module, a speaker, a receiver, a microphone, a headset jack, a sensor module, a button, a camera, and the like that are electrically connected to the processor. The sensor module may include a pressure sensor, a gyroscope sensor, a barometric pressure sensor, a magnetic sensor, an acceleration sensor, a distance sensor, an optical proximity sensor, a fingerprint sensor, a temperature sensor, a touch sensor, an ambient light sensor, a bone conduction sensor, and the like.

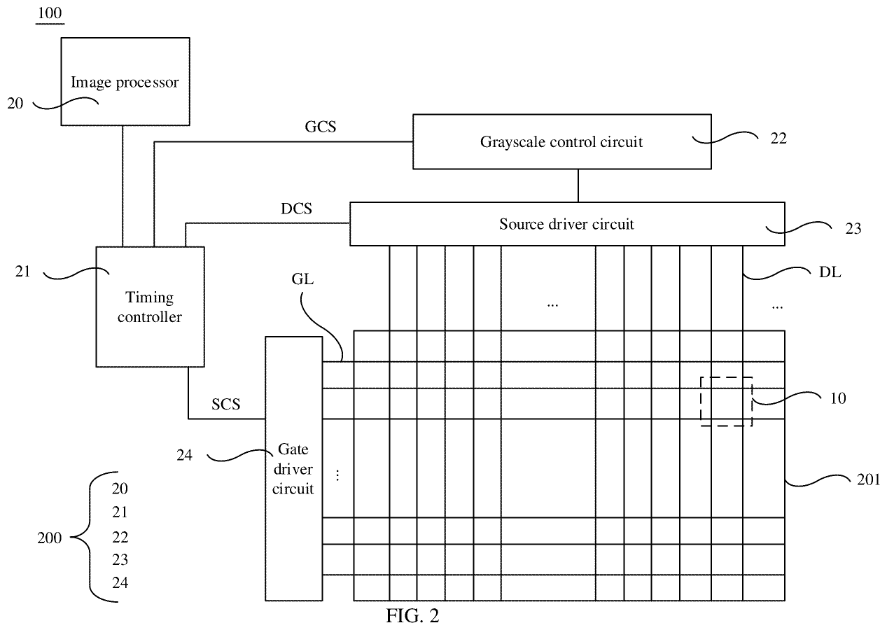

On this basis, as shown in FIG. 2, the display module 100 may include a display driver circuit 200 and a display 201. The processor may be electrically connected to the display driver circuit 200, to control the display driver circuit 200 to drive the display 201 to display an image.

In some embodiments of this application, the display 201 may be a liquid crystal display (LCD), an organic light-emitting diode (OLED) display, a micro (micro or mini) light-emitting diode (light-emitting diode) display, a quantum dot light-emitting diode (QLED) display, or the like. A type of the display is not limited in this application.

The display 201 includes a plurality of subpixels 10, and a pixel circuit (not shown in the figure) is disposed in the subpixel 10. For the LCD display, the pixel circuit may include at least one transistor, and a liquid crystal capacitor and a storage capacitor that are electrically connected to the transistor. For the OLED display, the QLED display, or the micro OLED display, the pixel circuit may include a light emitting device including an OLED, a QLED, or a micro OLED, a plurality of transistors, and a plurality of capacitors, for example, a pixel circuit of a 7T1C structure. Herein, T represents a transistor, and C represents a capacitor.

In addition, at least three adjacent subpixels used to emit three primary colors (for example, red, green, and blue) may form a pixel (pixel) of the display 201. In this embodiment of this application, as shown in FIG. 2, a pixel arrangement form of the display 201 may be a matrix form, or may be a PenTile pixel arrangement form (which may also be referred to as a P arrangement), a delta pixel arrangement form (which may also be referred to as a D arrangement), a diamond arrangement, or another form. The pixel arrangement form may be determined based on requirements of parameters such as a display effect, pixel density (PPI), and resolution. This is not limited in this application.

On this basis, as shown in FIG. 2, to enable the display 201 to be electrically connected to the display driver circuit 200, the display 201 may further include a data line (DL) and a gate line (gate line, GL) that intersect horizontally and vertically. In this example, subpixels 10 electrically connected to a same DL may be referred to as a column of subpixels, and subpixels 10 electrically connected to a same GL may be referred to as a row of subpixels. Specifically, the GL may be electrically connected to gates of some transistors in the pixel circuit in the subpixel 10, to control the transistors to be turned on or off. The DL may be electrically connected to sources (source) or drains (drain) of some transistors in the pixel circuit in the subpixel 10, to transmit a voltage Vdata (which may also be referred to as a data voltage) to the pixel circuit.

It should be noted that a type of the transistor in the pixel circuit is not limited in this application. For example, the transistor may be an N-type transistor, or may be a P-type transistor. Some transistors, for example, driving transistors, in the pixel circuit may be transistors with high mobility and a high conduction current, for example, low-temperature polycrystalline silicon (LTPS) transistors. The LTPS transistor may be a P-type transistor. For ease of description, the following provides descriptions by using an example in which the driving transistor in the pixel circuit is a P-type transistor.

In addition, still as shown in FIG. 2, the display driver circuit 200 may include an image processor 20, a timing controller (TCON) 21, a grayscale control circuit 22, a source driver circuit 23, and a gate driver circuit 24. The image processor 20 is electrically connected to the timing controller 21. The timing controller 21 is electrically connected to all of the grayscale control circuit 22, the source driver circuit 23, and the gate driver circuit 24. The grayscale control circuit 22 is electrically connected to the source driver circuit 23. The source driver circuit 23 is electrically connected to each DL, and the gate driver circuit 24 is electrically connected to each GL.

The image processor 20 may provide initial display signals and control signals of a plurality of frames of display images to the timing controller 21. The timing controller 21 may convert the initial display signals of all the frames of display images one by one based on an arrangement of the subpixels 10 in the display 201, to output converted display signals (briefly referred to as display signals below). In addition, the timing controller 21 may further generate, based on the control signals from the image processor 20, a scan control signal (SCS), a data control signal (DCS), and a gamma control signal (GCS) for controlling display signal driving timing. Based on this, the timing controller 21 may transmit the scan control signal SCS to the gate driver circuit 24, transmit the data control signal DCS to the source driver circuit 23, and transmit the gamma control signal GCS to the grayscale control circuit 22.

The gate driver circuit 24 may scan each gate line GL row by row under control of the scan control signal SCS, to gate the subpixels 10 row by row. In this case, some transistors in the gated subpixel 10 are in an on state. The grayscale control circuit 22 may generate a plurality of grayscale voltages under control of the gamma control signal GCS. In addition, the source driver circuit 23 generates a plurality of voltages Vdata based on the data control signal DCS, the display signals output by the timing controller 21, and the grayscale voltages output by the grayscale control circuit 22.

On this basis, the source driver circuit 23 may transmit the voltage Vdata to a corresponding DL. In this way, the voltage Vdata can be transmitted, through the DL, to a subpixel 10 that is electrically connected to the DL and that is gated by the GL, to drive the subpixel 10 to emit light, so as to implement image display. A grayscale displayed by the subpixel 10 matches the voltage Vdata input to the subpixel 10.

In addition, still as shown in FIG. 2, areas in which all subpixels 10 are located may form a display area of the display 201. The display driver circuit 200 may be disposed around the display area, in other words, not disposed in the display area. In some embodiments of this application, the gate driver circuit 24 and the transistor in the subpixel 10 may be simultaneously prepared.

Alternatively, in some other embodiments, the gate driver circuit 24 may be packaged in at least one chip. The chip may be electrically connected to the pixel circuit by using a chip on film (COF) process or a chip on glass (COG) process. Similarly, the source driver circuit 23 may be packaged in at least one chip. The chip may be electrically connected to the pixel circuit by using the COF process or the COG process.

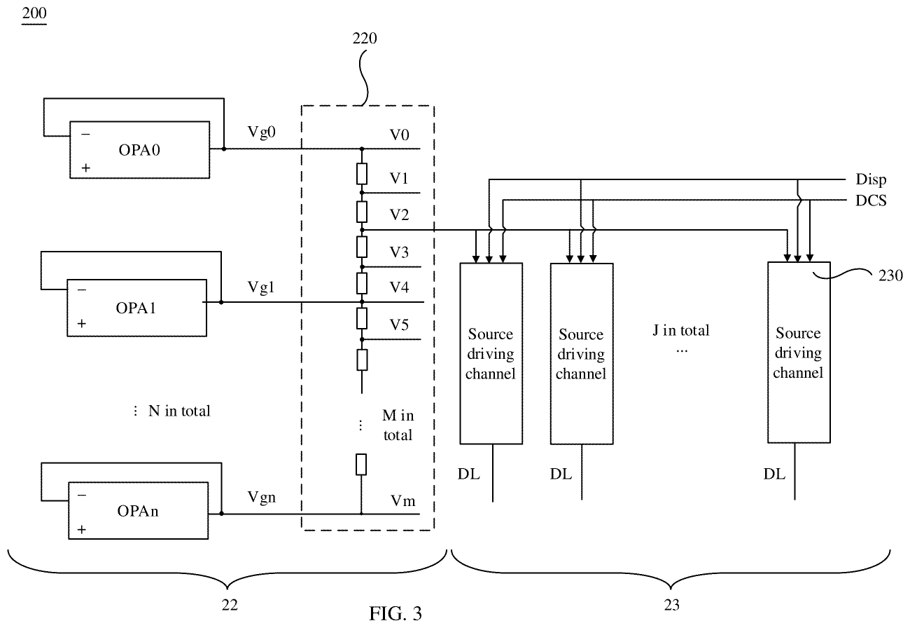

The following describes in detail structures of the grayscale control circuit 22 and the source driver circuit 23 by using examples. In some embodiments of this application, as shown in FIG. 3, the grayscale control circuit 22 may include N gamma operational amplifiers (OPAs): OPA0, OPA1, . . . , and OPAn. The N gamma operational amplifiers may be sequentially arranged, and each gamma operational amplifier is configured to output a gamma reference voltage. Therefore, the N gamma operational amplifiers may respectively output N gamma reference voltages. Herein, N≥2, and N is an integer.

For example, in FIG. 3, gamma reference voltages Vg0, Vg1, . . . , and Vgn respectively output by OPA0, OPA1, . . . , and OPAn may decrease successively. In this case, the gamma reference voltage output by the first gamma operational amplifier OPA0 may be a maximum value, that is, an upper-limit gamma reference voltage Vgmax, in all gamma reference voltages output by the grayscale control circuit 22, and the gamma reference voltage Vgn output by the second gamma operational amplifier may be a minimum value, that is, a lower-limit gamma reference voltage Vgmin, in all the gamma reference voltages output by the grayscale control circuit 22.

Alternatively, for another example, gamma reference voltages Vg0, Vg1, . . . , and Vgn respectively output by OPA0, OPA1, . . . , and OPAn may increase successively. In this case, the gamma reference voltage output by the first gamma operational amplifier OPA0 may be a minimum value, that is, a lower-limit gamma reference voltage Vgmin, in all gamma reference voltages output by the grayscale control circuit 22, and the gamma reference voltage Vgn output by the second gamma operational amplifier may be a maximum value, that is, an upper-limit gamma reference voltage Vgmax, in all the gamma reference voltages output by the grayscale control circuit 22.

It should be noted that for ease of description, the following provides descriptions by using an example in which the gamma reference voltages Vg0, Vg1, . . . , and Vgn decrease successively, the gamma reference voltage Vg0 is the upper-limit gamma reference voltage Vgmax, and the gamma reference voltage Vgn is the lower-limit gamma reference voltage Vgmin. Based on this, in the following embodiments, Vg0 represents the upper-limit gamma reference voltage, and Vgn represents the lower-limit gamma reference voltage. In addition, in FIG. 3, descriptions are provided by using an example in which OPA0, OPA1, . . . , or OPAn is a negative feedback operational amplifier. In some other embodiments of this application, OPA0, OPA1, . . . , or OPAn may alternatively use a positive feedback form. This is not limited in this application.

On this basis, the grayscale control circuit 22 may further include a resistor string 220 shown in FIG. 3. The resistor string 220 may include a plurality of voltage divider resistors connected in series. At least one voltage divider resistor may be connected between two adjacent gamma operational amplifiers, for example, between OPA0 and OPA1. For example, a quantity of voltage divider resistors between the two adjacent gamma operational amplifiers may be set with reference to a gamma curve.

In this case, the resistor string 220 may be configured to perform voltage division on output terminals of the two adjacent gamma operational amplifiers, so that the resistor string 220 can output a plurality of (for example, M) grayscale voltages (V0, V1, . . . , and Vm). Herein, 2≤m≤M, and M is an integer. The M grayscale voltages (V0, V1, . . . , and Vm) may include the N gamma reference voltages (Vg0, Vg1, . . . , and Vgn). For example, as shown in FIG. 3, the grayscale voltage V0 is the upper-limit gamma reference voltage Vg0, the grayscale voltage V4 is the lower-limit gamma reference voltage Vg1, and the grayscale voltage Vm is the gamma reference voltage Vgn.

In addition, in addition to the N gamma reference voltages (Vg0, Vg1, . . . , and Vgn), the M grayscale voltages (V0, V1, . . . , and Vm) further include a voltage obtained after voltage division is performed between two adjacent gamma reference voltages through the voltage divider resistor. For example, the grayscale voltages V1, V2, V3, and V4 in FIG. 3 are voltages obtained after voltage division is separately performed between the gamma reference voltage Vg0 and the gamma reference voltage Vg1 through four voltage divider resistors.

Based on this, in the M grayscale voltages (V0, V1, . . . , and Vm), all of the grayscale voltages V1, V2, . . . , and Vm-1 fall within a voltage range of (Vm-V0). It may be learned from the foregoing descriptions that the grayscale voltage V0 is the upper-limit gamma reference voltage Vg0, and the grayscale voltage V4 is the lower-limit gamma reference voltage Vg1. Therefore, in the M grayscale voltages (V0, V1, . . . , and Vm), all of the grayscale voltages V1, V2, . . . , and Vm-1 fall within a voltage range of (Vgn-Vg0).

Specifically, in the M grayscale voltages (V0, V1, . . . , and Vm), each grayscale voltage may correspond to one grayscale value. For example, when the display 201 can display 64 grayscales, M=64. For another example, when the display 201 can display 256 grayscales, M=256. A higher grayscale voltage indicates a corresponding smaller grayscale value and lower brightness displayed by the subpixel. In this case, the grayscale voltages V0, V1, . . . , and Vm decrease successively, and grayscale values respectively corresponding to the grayscale voltages V0, V1, . . . , and Vm increase successively.

On this basis, the source driver circuit 23 may include a plurality of (for example, J) source driving channels (channel, CH) 230 shown in FIG. 3. A quantity (for example, J=2560) of source driving channels 230 may be the same as a quantity of DLs in the display 201. For example, if 2560 columns of DLs are disposed in the display 201, the source driver circuit 23 may include 2560 source driving channels 230. One end of each DL is connected to an output terminal of one source driving channel 230, and the other end is electrically connected to a pixel circuit of a same column of subpixels. Herein, J≥2, and J is an integer.

Based on this, the source driving channel 230 may be electrically connected to the resistor string 220 and the timing controller 21 (shown in FIG. 2). The source driving channel 230 is configured to: select, under control of the display signal Disp and the data control signal DCS provided by the timing controller 21, a grayscale voltage from the M grayscale voltages (V0, V1, . . . , and Vm) output by the resistor string 220, and generate a voltage Vdata.

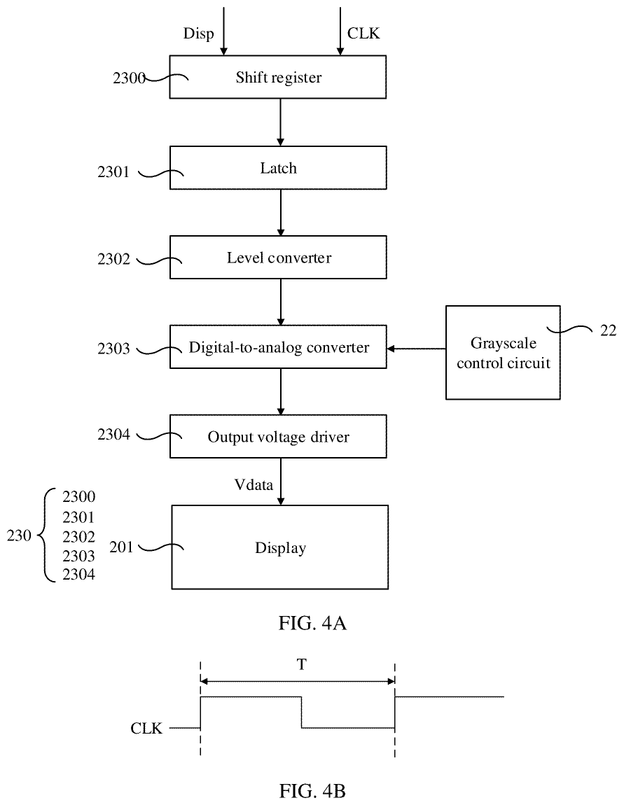

In addition, the data control signal DCS provided by the timing controller 21 may include a horizontal synchronization signal and a clock signal CLK. The clock signal CLK is used to control a time of writing and outputting the horizontal synchronization signal, to determine a sequence of outputting the voltage Vdata by the J source driving channels 230. Based on this, as shown in FIG. 4A, the source driving channel 230 may include a shift register 2300, a latch 2301, a level converter 2302, a digital-to-analog (D/A) converter 2303, and an output voltage driver 2304.

The shift register 2300 may include a bidirectional shift register (Bidirectional Shift Register). The shift register 2300 may be electrically connected to the timing controller 21 and the level converter 2302. The shift register 2300 and the latch 2301 may transmit the display signal Disp to the level converter 2302 under control provided by the timing controller 21. For example, as shown in FIG. 4B, when the clock signal CLK output by the timing controller 21 is at a rising edge, the shift register 2300 may input the horizontal synchronization signal to the latch 2301, and the latch 2301 may latch the received display signal Disp.

In addition, as shown in FIG. 4B, when the clock signal CLK is at a falling edge, the latch 2301 may output the horizontal synchronization signal, and output the latched display signal Disp to the level converter 2302. For example, a cycle of the clock signal CLK shown in FIG. 4B may be 3.7 μs. The cycle of the clock signal CLK is not limited in this application.

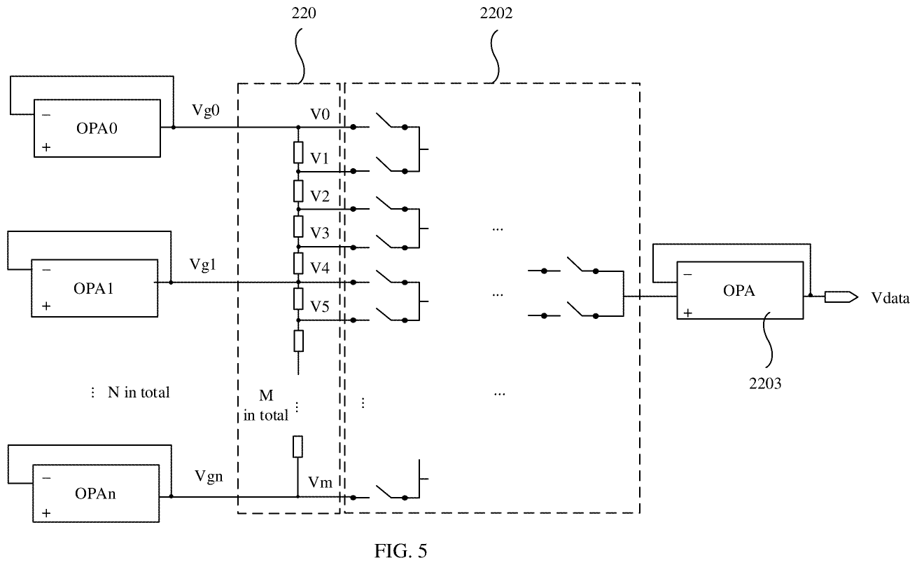

In addition, as shown in FIG. 4A, the level converter 2302 is electrically connected to the digital-to-analog converter 2303. The level converter 2302 is configured to boost the display signal from the latch, and transmit the boosted display signal to the digital-to-analog converter 2303. Based on this, as shown in FIG. 5, the digital-to-analog converter 2303 may be electrically connected to the resistor string 220. The digital-to-analog converter 2303 may include a plurality of cascaded control switch groups, and each control switch group includes a plurality of control switches connected in parallel.

The display signal output by the level converter 2302 may be a digital signal (for example, 6 bits or 8 bits), and each binary number “0” or “1” in the digital signal may be used to separately control, through a serial-to-parallel converter, a plurality of control switches in the digital-to-analog converter 2303 to be turned on or off, so that a control switch that is turned on may output a grayscale voltage connected to the control switch, to select a grayscale voltage from the M grayscale voltages (V0, V1, . . . , and Vm), so as to implement conversion from a digital signal to an analog signal.

On this basis, as shown in FIG. 4A, the output voltage driver 2304 may be electrically connected to the digital-to-analog converter 2303, and is configured to: convert the grayscale voltage from the digital-to-analog converter 2303 into a voltage Vdata, and output the voltage Vdata. For example, the output voltage driver 2304 may include an operational amplifier, and the operational amplifier amplifies the grayscale voltage, to use the grayscale voltage as a voltage Vdata for driving the subpixel in the display 201 for display.

In conclusion, as shown in FIG. 3, in the display driver circuit 200, the N gamma operational amplifiers (OPA0, OPA1, . . . , and OPAn) may respectively output the N gamma reference voltages (Vg0, Vg1, . . . , and Vgn). Under voltage division action of the resistor string 220, the resistor string 220 may output the M grayscale voltages (V0, V1, . . . , and Vm). All of the M grayscale voltages fall within the voltage range of (Vgn-Vg0).

In this case, in the J source driving channels 230 electrically connected to the resistor string 220, each source driving channel 230 may select a grayscale voltage from the M grayscale voltages (V0, V1, . . . , and Vm) based on the data control signal DCS and the display signal Disp that are output by the timing controller 21, convert the grayscale voltage into a voltage Vdata, and output the voltage Vdata to a DL electrically connected to the source driving channel 230.

Based on this, as shown in FIG. 2, the DL is electrically connected to a column of subpixels 10 (as shown in FIG. 2). When the gate driver circuit 24 gates a row of subpixels 10, the DL may transmit the voltage Vdata to a pixel circuit of the gated subpixel 10, to drive the subpixel 10 to emit light, so that a grayscale displayed by the subpixel 10 matches the received voltage Vdata. For example, when the driving transistor in the subpixel 10 is a P-type transistor, and the subpixel 10 displays a small grayscale value, the source driving channel 230 may provide a high voltage Vdata to the subpixel 10. When the subpixel 10 displays a large grayscale value, the source driving channel 230 may provide a low voltage Vdata to the subpixel 10.

It may be learned from the foregoing descriptions that as shown in FIG. 3, each source driving channel 230 in the J source driving channels 230 may be electrically connected to all of the N gamma operational amplifiers (OPA0, OPA1, . . . , and OPAn) through the resistor string 220. In addition, one source driving channel 230 may be electrically connected to a column of subpixels 10 (as shown in FIG. 2) through one DL.

In this case, in some embodiments of this application, when there is a large difference between grayscale values displayed by two adjacent rows of subpixels 10 in a same column, for example, a current row of subpixels 10 displays a grayscale of 0, and a next row of subpixels 10 displays a grayscale of 255, there is a large difference between voltages Vdata provided by a source driving channel 230 connected to the column of subpixels 10 to the two adjacent rows of subpixels 10. In this way, when the source driving channel 230 drives the next row of subpixels 10 for display, an output voltage change swing of the source driving channel 230 is large (for example, a voltage difference is ΔV≥6 V). Consequently, when the source driving channel 230 drives the next row of subpixels 10 for display, load of a gamma operational amplifier configured to provide a grayscale value to the source driving channel 230 increases.

It should be noted that the gamma operational amplifier configured to provide the grayscale value to the source driving channel 230 means that for a grayscale voltage that matches the display signal output by the source driving channel 230, when the gamma reference voltage output by the foregoing gamma operational amplifier is directly used as the grayscale voltage (for example, V0, V4, and Vm shown in FIG. 3) after passing through the resistor string 220 and output to the source driving channel 230, the gamma operational amplifier is the gamma operational amplifier configured to provide the grayscale value to the source driving channel 230.

For example, when the grayscale voltage that matches the display signal output by the source driving channel 230 is a voltage corresponding to a white grayscale, in the N gamma operational amplifiers (OPA0, OPA1, . . . , and OPAn), the lower-limit gamma reference voltage Vgn output by the second gamma operational amplifier OPAn is directly used as the grayscale voltage Vm after passing through the resistor string 220 and output to the source driving channel 230, to drive the subpixel to display the white grayscale. In this case, the second gamma operational amplifier OPAn is the gamma operational amplifier configured to provide the grayscale value to the source driving channel 230.

Alternatively, when the grayscale voltage that matches the display signal output by the source driving channel 230 is a voltage corresponding to a black grayscale, in the N gamma operational amplifiers (OPA0, OPA1, . . . , and OPAn), the upper-limit gamma reference voltage Vg0 output by the first gamma operational amplifier OPA0 is directly used as the grayscale voltage V0 after passing through the resistor string 220 and output to the source driving channel 230, to drive the subpixel to display the black grayscale. In this case, the first gamma operational amplifier OPA0 is the gamma operational amplifier configured to provide the grayscale value to the source driving channel 230.

Alternatively, for another example, the gamma operational amplifier configured to provide the grayscale value to the source driving channel 230 may alternatively mean that for a grayscale voltage that matches the display signal output by the source driving channel 230, when the gamma reference voltage output by the foregoing gamma operational amplifier is used as the grayscale voltage (for example, V1, V2, and V3 shown in FIG. 3) after being divided by the resistor string 220 and output to the source driving channel 230, at least one gamma operational amplifier at two ends of the voltage divider resistor may be the gamma operational amplifier configured to provide the grayscale value to the source driving channel 230.

In addition, the gate driver circuit 24 in FIG. 2 may scan the subpixels 10 row by row, to gate the subpixels 10 in the display 201 row by row. Based on this, in this embodiment of this application, the current row of subpixels is a row of subpixels currently gated by the gate driver circuit 24. The next row of subpixels is a row of subpixels to be gated after the gate driver circuit 24 gates the current row of subpixels.

Therefore, in this embodiment of this application, the two adjacent rows of subpixels, that is, the current row of subpixels and the next row of subpixels, are two rows of subpixels sequentially adjacent in a gating sequence. The two rows of subpixels adjacent in the gating sequence may be two rows of physically adjacent subpixels. For example, when the gate driver circuit 24 gates the subpixels 10 row by row, the current row of subpixels and the next row of subpixels are usually two rows of physically adjacent subpixels.

Alternatively, for another example, when the gate driver circuit 24 gates the subpixels 10 row by row for odd-numbered rows (or even-numbered rows), there may be an even-numbered quantity of rows (or an odd-numbered quantity of rows) of subpixels between the current row of subpixels and the next row of subpixels. A manner in which the gate driver circuit 24 gates the subpixels is not limited in this application, provided that it can be ensured that the current row of subpixels and the next row of subpixels are two rows of subpixels sequentially adjacent in the gating sequence.

On this basis, when all of a plurality of source driving channels 230 electrically connected to one (OPA0, OPA1, . . . , or OPAn) of the N gamma operational amplifiers exhibit a large output voltage change swing, the gamma operational amplifier is in a heavy-load state. The gamma operational amplifier (OPA0, OPA1, . . . , or OPAn) in the heavy-load state needs to have good stability and thrust (driving capability), to ensure that a display effect of the display meets a preset requirement.

Alternatively, in some other embodiments of this application, when there is a small difference between grayscale values displayed by two adjacent rows of subpixels 10 in a same column, for example, a current row of subpixels 10 displays a grayscale of 125, and a next row of subpixels 10 displays a grayscale of 127, there is a small difference between voltages Vdata provided by a source driving channel 230 connected to the column of subpixels 10 to the two adjacent rows of subpixels 10. In this way, when the source driving channel 230 drives the next row of subpixels 10 for display, an output voltage change swing of the source driving channel 230 is small (for example, a voltage difference ΔV is less than 6 V). In this case, when the source driving channel 230 drives the next row of subpixels 10 for display, load of a gamma operational amplifier configured to provide a grayscale value to the source driving channel 230 is light.

On this basis, when most of a plurality of source driving channels 230 electrically connected to one (OPA0, OPA1, . . . , or OPAn) of the N gamma operational amplifiers exhibit a small output voltage change swing, the gamma operational amplifier is in a light-load state. The gamma operational amplifier (OPA0, OPA1, . . . , or OPAn) in the light-load state does not need large thrust, and stability is ensured. In this case, the gamma operational amplifier needs to have low power consumption, to help reduce power consumption of the entire electronic device.

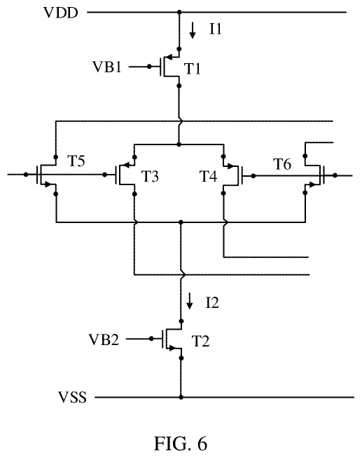

Based on this, an input stage of any one (OPA0, OPA1, . . . , or OPAn) of the N gamma operational amplifiers may include a first current source including a transistor T1, a second current source including a transistor T2, a first differential amplifier including transistors T3 and T4, and a second differential amplifier including transistors T5 and T6, as shown in FIG. 6. In some embodiments of this application, the transistors T1, T3, and T4 may be P-type transistors, and the transistors T2, T5, and T6 may be N-type transistors.

The first current source (the transistor T1) may provide a bias current I1 to the first differential amplifier (T3 and T4) under action of a bias voltage VB1. In addition, the second current source (the transistor T2) provides a constant bias current I2 to the second differential amplifier (T5 and T6) under action of a bias voltage VB2. Herein, I1 may be equal to I2. Stability and thrust of the gamma operational amplifier are related to the bias voltage VB1 (or the bias voltage VB2) and the bias current I1 (or the bias current I2).

For example, when the gamma operational amplifier works in the heavy-load state, the bias voltage VB1 (or the bias voltage VB2) may be increased, to increase the bias current I1 (or the bias current I2), so that the gamma operational amplifier has good stability and thrust. Alternatively, for another example, when the gamma operational amplifier works in the light-load state, to reduce power consumption of the gamma operational amplifier, the bias voltage VB1 (or the bias voltage VB2) may be decreased, to decrease the bias current I1 (or the bias current I2).

Based on this, in this application, a dynamic frequency compensation (DFC) manner may be used, that is, the bias voltage is dynamically provided to the gamma operational amplifier based on a load condition of the gamma operational amplifier, to dynamically adjust a phase margin (PM) of the gamma operational amplifier, so that the gamma operational amplifier has good stability and thrust in a heavy-load condition, and has low power consumption in a light-load condition. The phase margin of the gamma operational amplifier is used to feed back the stability of the gamma operational amplifier.

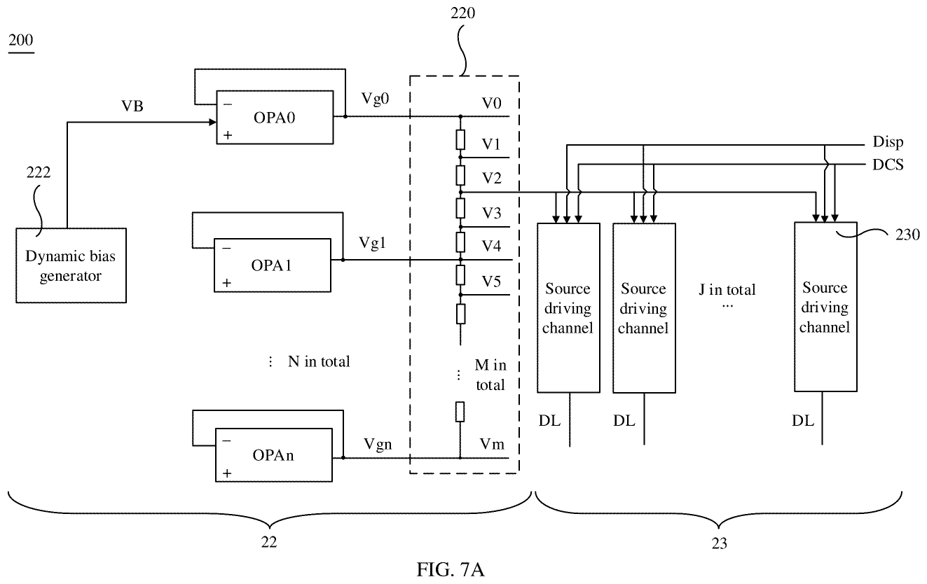

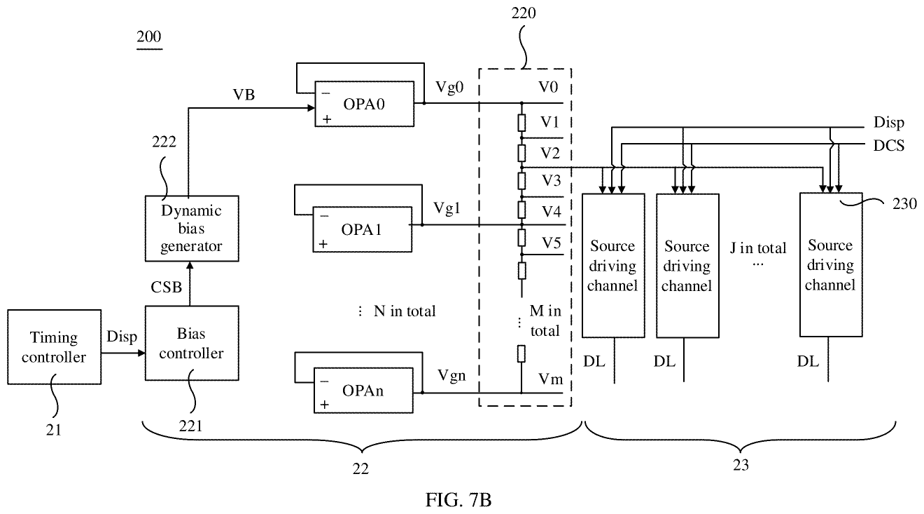

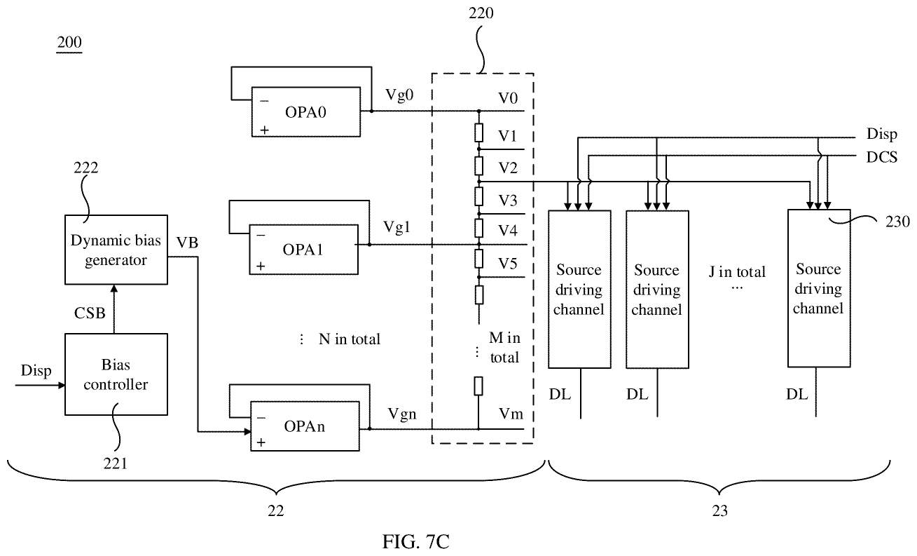

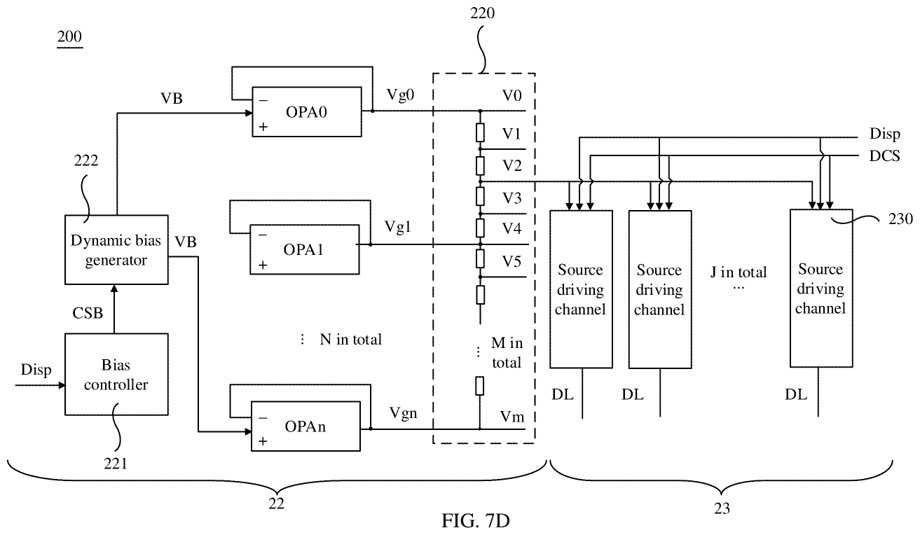

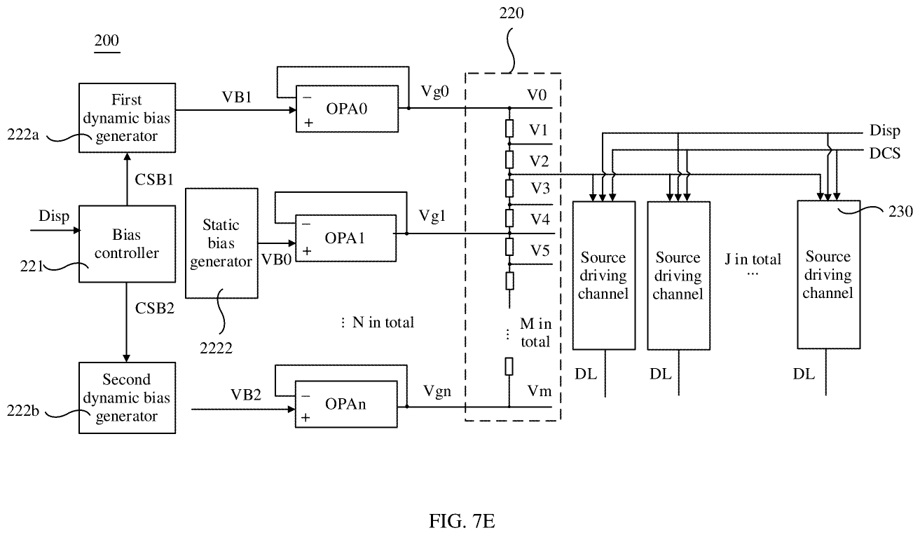

Based on this, to implement the DFC process, the grayscale control circuit 22 (as shown in FIG. 2) in the display driver circuit 200 provided in this embodiment of this application may further include at least one dynamic bias generator 222, as shown in FIG. 7A. At least one (OPA0, OPA1, . . . , or OPAn) of the N gamma operational amplifiers is electrically connected to the dynamic bias generator 222. The dynamic bias generator 222 is configured to output a dynamically adjustable bias voltage, so that a bias voltage VB (for example, the bias voltage VB1 or the bias voltage VB2 shown in FIG. 6) from the gamma operational amplifier can be dynamically adjusted through the dynamic bias generator 222.

It should be noted that in FIG. 7A, descriptions are provided by using the dynamic bias generator 222 and the first gamma operational amplifier OPA0 as an example. However, this does not constitute a limitation on the electrical connection between the dynamic bias generator 222 and the gamma operational amplifier.

In this way, when the gamma operational amplifier is in the heavy-load state, the dynamic bias generator 222 may provide a high bias voltage VB to the gamma operational amplifier (OPA0, OPA1, . . . , or OPAn) electrically connected to the dynamic bias generator 222, to increase a bias current (for example, the bias current I1 or the bias current I2 shown in FIG. 6), so that the gamma operational amplifier has good stability and thrust. Alternatively, for another example, when the gamma operational amplifier (OPA0, OPA1, . . . , or OPAn) electrically connected to the dynamic bias generator 222 is in the light-load state, the dynamic bias generator 222 may provide a low bias voltage VB to the gamma operational amplifier, to decrease a bias current. This can help reduce power consumption of the gamma operational amplifier. On this basis, the resistor string 220 generates a plurality of grayscale voltages through voltage division by using a plurality of gamma voltages, so that the source driving channel 230 can convert any grayscale voltage into a voltage Vdata, and provide the voltage Vdata to the subpixel in the display to drive the subpixel for display. It may be learned from the foregoing descriptions that the gamma operational amplifier in the display driver circuit 200 provided in this embodiment of this application may receive a dynamically adjustable bias voltage based on a load condition. In this way, the gamma operational amplifier and the entire display driver circuit 200 can have good stability and thrust without a need to over-design the gamma operational amplifier in the heavy-load condition, and the gamma operational amplifier and the entire display driver circuit 200 have low power consumption in the light-load state.

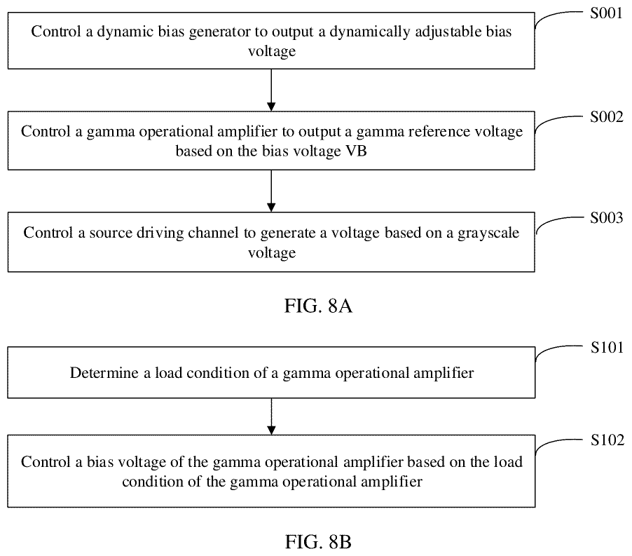

Based on the structure of the display driver circuit 200 shown in FIG. 7A, this application provides a control method for a display driver circuit 200. Technical effects of the control method are the same as those described above. Details are not described herein. Specifically, the method includes steps S001 to S003 shown in FIG. 8A.

S001: Control a dynamic bias generator to output a dynamically adjustable bias voltage.

For example, based on a load condition, for example, heavy load or light load, of a gamma operational amplifier electrically connected to the dynamic bias generator 222, the dynamic bias generator 222 outputs a high bias voltage VB under heavy load, and outputs a low bias voltage VB under light load.

S002: Control the gamma operational amplifier to output a gamma reference voltage based on the bias voltage VB.

Specifically, after receiving the bias voltage VB from the dynamic bias generator 222, the gamma operational amplifier (OPA0, OPA1, . . . , or OPAn) electrically connected to the dynamic bias generator 222 may have good stability and thrust in a heavy-load condition, have low power consumption in a light-load state, and output a gamma reference voltage (Vg0, Vg1, . . . , or Vgn).

S003: Control a source driving channel 230 to generate a voltage based on a grayscale voltage.

Specifically, the source driving channel 230 may convert any grayscale voltage from a resistor string 220 into a voltage Vdata, and provide the voltage Vdata to a subpixel in a display to drive the subpixel for display.

It may be learned from the foregoing descriptions that the bias voltage VB output to the gamma operational amplifier may be dynamically adjusted based on a load condition (light load or heavy load) of the gamma operational amplifier (OPA0, OPA1, . . . , or OPAn) electrically connected to the dynamic bias generator 222. Based on this, in some embodiments of this application, as shown in FIG. 7B, the display driver circuit 200 may further include a bias controller 221. The bias controller 221 is electrically connected to the dynamic bias generator 222, and the bias controller 221 is configured to output a bias control signal CSB. In this case, the dynamic bias generator 222 may output the dynamically adjustable bias voltage VB based on the bias control signal CSB.

In this way, the bias controller 221 can output, based on a load condition (light load or heavy load) of the gamma operational amplifier (OPA0, OPA1, . . . , or OPAn) electrically connected to the dynamic bias generator 222, a bias control signal CSB that matches the load condition, to dynamically adjust the bias voltage VB output by the dynamic bias generator 222.

Based on this, in some embodiments of this application, when change of an image displayed by an electronic device 01 follows a fixed pattern in a time period (for example, black and white pictures are alternately displayed row by row), the gamma operational amplifier (OPA0, OPA1, . . . , or OPAn) has a fixed load condition in the time period. In this case, data of the load condition of the gamma operational amplifier may be stored in a memory, and the bias controller 221 may invoke the data from the memory, to obtain the load condition of the gamma operational amplifier, and output a corresponding bias control signal CSB.

Alternatively, in some other embodiments of this application, the bias controller 221 may output the bias control signal CSB based on a display signal. In this case, as shown in FIG. 7B, the bias controller 221 is electrically connected to a timing controller 21, and the timing controller 21 may provide a display signal to the bias controller 221, so that the bias controller 221 can learn of a load condition (light load or heavy load) of the gamma operational amplifier based on the display signal, and further the bias controller 221 outputs a bias control signal that matches the load condition, to dynamically adjust the bias voltage VB output by the dynamic bias generator 222. Based on the structure of the display driver circuit 200 shown in FIG. 7B, this application provides a control method for a display driver circuit 200. The method includes steps S101 and S102 shown in FIG. 8B.

S101: Determine a load condition of a gamma operational amplifier.

Specifically, in a process of performing S101, a bias controller 221 may be controlled to receive a display signal Disp provided by a timing controller 21, calculate a voltage difference ΔV between two adjacent rows of display signals Disp in a same column based on the display signal Disp, and if the voltage difference ΔV is greater than or equal to a preset voltage threshold Vth (that is, ΔV≥Vth), perform counting, and output at least one bias control signal CSB based on a counting result.

That the bias controller 221 outputs the at least one bias control signal CSB based on the counting result may include: The bias controller 221 compares a counting result of a quantity of times ΔV≥Vth with a preset counting threshold, and if the counting result is greater than or equal to the preset counting threshold Cth, generate the bias control signal CSB.

It should be noted that a value of the preset voltage threshold Vth may be coordinated with a value of the preset counting threshold Cth, so that when the voltage difference ΔV between the two adjacent rows of display signals Disp reaches the preset voltage threshold Vth, and the counting result reaches the preset counting threshold Cth, stability and thrust of the gamma operational amplifier working in a heavy-load state are up to a limit, and a display effect of an electronic device 01 is a poorest acceptable display effect.

Based on this, when the value of the preset voltage threshold Vth is large, for example, 6 V, the value of the preset counting threshold Cth may be set to be small, for example, 500. Alternatively, when the value of the preset voltage threshold Vth is small, for example, 4 V, the value of the preset counting threshold Cth may be set to be large, for example, 1500. In addition, a maximum value of the preset counting threshold Cth may be the same as a quantity of columns of the display signal Disp. The quantity of columns of the display signal Disp may be a quantity J of source driving channels 230. For example, when J=2560, the maximum value of the preset counting threshold is Cth_max=2560.

S102: Control a bias voltage of the gamma operational amplifier based on the load condition of the gamma operational amplifier.

Specifically, the dynamic bias generator 222 may be configured to output the bias voltage VB based on the bias control signal CSB. Based on this, at least one gamma operational amplifier (for example, OPA0) in N gamma operational amplifiers (OPA0, OPA1, . . . , and OPAn) may be electrically connected to the dynamic bias generator 222, so that the gamma operational amplifier (for example, OPA0) can output a gamma reference voltage (for example, Vg1) under action of the bias voltage VB. Based on this, the dynamic bias generator 222 provides a bias voltage VB (for example, the bias voltage VB1 or the bias voltage VB2 shown in FIG. 6) to the gamma operational amplifier (for example, OPA0).

In conclusion, the display driver circuit 200 provided in some embodiments of this application may include the bias controller 221, the dynamic bias generator 222, and the N gamma operational amplifiers (OPA0, OPA1, . . . , and OPAn) shown in FIG. 7B. In a process in which the bias controller 221 compares the two adjacent rows of display signals Disp in the same column to calculate the voltage difference ΔV, and determines whether the voltage difference ΔV is greater than or equal to the preset voltage threshold Vth (for example, Vth=6 V), when at least one source driving channel 230 drives a next row of subpixels 10 for display, the bias controller 221 may determine an output voltage change swing status (for example, a large or small change swing) of the source driving channel 230. Based on this, the bias controller 221 may determine a load condition of a gamma operational amplifier (for example, OPA0) configured to provide a grayscale value to the source driving channel 230.

In addition, the bias controller 221 may further count a quantity of times the voltage difference ΔV is greater than or equal to the preset voltage threshold Vth. Therefore, the bias controller 221 may further count a quantity of source driving channels 230 that exhibit a large output voltage change swing in the J source driving channels 230, to determine whether the gamma operational amplifier (for example, OPA0) electrically connected to the dynamic bias generator 222 is in a heavy-load state or a light-load state. In addition, the bias controller 221 may generate the bias control signal CSB based on a determining result.

On this basis, the dynamic bias generator 222 may output, based on the bias control signal CSB, a bias voltage VB that matches the bias control signal CSB. For example, when the bias controller 221 determines that the gamma operational amplifier (for example, OPA0) configured to provide the grayscale value to the source driving channel 230 is in the heavy-load state, the dynamic bias generator 222 may provide a high bias voltage VB to the gamma operational amplifier (for example, OPA0) based on the bias control signal CSB from the bias controller 221. In this way, an input stage of the gamma operational amplifier (for example, OPA0) can have a high bias current I1 (as shown in FIG. 6), so that the gamma operational amplifier (for example, OPA0) has good stability and thrust.

Alternatively, for another example, when the bias controller 221 determines that the gamma operational amplifier (for example, OPA0) configured to provide the grayscale value to the source driving channel 230 is in the light-load state, the dynamic bias generator 222 may provide a low bias voltage VB to the gamma operational amplifier (for example, OPA0) based on the bias control signal CSB from the bias controller 221. In this way, an input stage of the gamma operational amplifier (for example, OPA0) can have a low bias current I1 (as shown in FIG. 6), to help reduce power consumption of the gamma operational amplifier (for example, OPA0).

It may be learned from the foregoing descriptions that all of M grayscale voltages (V0, V1, . . . , and Vm) output by a resistor string 220 shown in FIG. 7B fall within a voltage range of (Vgn-Vg0). In some embodiments of this application, in the N gamma operational amplifiers (OPA0, OPA1, . . . , and OPAn), the first gamma operational amplifier OPA0 is configured to output an upper-limit gamma reference voltage Vg0, which is used as a maximum value of the voltage range of (Vgn-Vg0). For example, a voltage value of the upper-limit gamma reference voltage Vg0 may be close to a first working voltage VDD in FIG. 6. For example, the upper-limit gamma reference voltage Vg0 may fall within a range of 6 V to 8 V.

In addition, the second gamma operational amplifier OPAn shown in FIG. 7B is configured to output a lower-limit gamma reference voltage Vgn, which is used as a minimum value of the voltage range of (Vgn-Vg0). For example, a voltage value of the lower-limit gamma reference voltage Vgn may be close to a second working voltage VSS in FIG. 6. For example, the lower-limit gamma reference voltage Vgn may fall within a range of 0.2 V to 2.5 V.

In this case, in some embodiments of this application, as shown in FIG. 7B, when grayscales of current rows of display signals of most of the J source driving channels 230, for example, all the source driving channels 230, are a minimum grayscale, for example, a grayscale of 0 (a black picture), and grayscales of next rows of display signals are a maximum grayscale, for example, a grayscale of 255 (a white picture), the second gamma operational amplifier OPAn needs to provide the lower-limit gamma reference voltage Vgn to each of the J source driving channels 230, and a swing of a voltage difference ΔV between two adjacent rows of display signals output by the source driving channel 230 is largest.

Alternatively, in some other embodiments of this application, as shown in FIG. 7B, when grayscales of current rows of display signals of most of the J source driving channels 230, for example, all the source driving channels 230, are a maximum grayscale, for example, a grayscale of 255 (a white picture), and grayscales of next rows of display signals are a minimum grayscale, for example, a grayscale of 0 (a black picture), the first gamma operational amplifier OPA0 needs to provide the upper-limit gamma reference voltage Vg0 to each of the J source driving channels 230, and a swing of a voltage difference ΔV between two adjacent rows of display signals output by the source driving channel 230 is largest.

In addition, the upper-limit gamma reference voltage Vg0 output by the first gamma operational amplifier OPA0 is close to the first working voltage VDD in FIG. 6, and the voltage value of the lower-limit gamma reference voltage Vgn output by the second gamma operational amplifier OPAn may be close to the second working voltage VSS in FIG. 6. Therefore, input currents of the first gamma operational amplifier OPA0 and the second gamma operational amplifier OPAn decrease, and an overall operational amplifier speed decreases.

In this way, when the first gamma operational amplifier OPA0 or the second gamma operational amplifier OPAn needs to drive all the source driving channels 230, the first gamma operational amplifier OPA0 or the second gamma operational amplifier OPAn is in an extreme heavy-load state, and stability and thrust of the first gamma operational amplifier OPA0 or the second gamma operational amplifier OPAn are challenged.

To resolve the foregoing problem, in some embodiments of this application, as shown in FIG. 7B, the first gamma operational amplifier OPA0 may be electrically connected to the dynamic bias generator 222, to compensate the thrust and the stability of the first gamma operational amplifier OPA0 in the heavy-load state, and reduce power consumption of the first gamma operational amplifier OPA0 in the light-load state, in the foregoing DFC manner.

Alternatively, in some other embodiments of this application, as shown in FIG. 7C, the second gamma operational amplifier OPAn may be electrically connected to the dynamic bias generator 222, to compensate the thrust and the stability of the second gamma operational amplifier OPAn in the heavy-load state, and reduce power consumption of the second gamma operational amplifier OPAn in the light-load state, in the foregoing DFC manner.

Alternatively, in some other embodiments of this application, as shown in FIG. 7D, both the first gamma operational amplifier OPA0 and the second gamma operational amplifier OPAn may be electrically connected to the dynamic bias generator 222, to compensate the thrust and the stability of the first gamma operational amplifier OPA0 and the second gamma operational amplifier OPAn in the heavy-load state, and reduce power consumption of the first gamma operational amplifier OPA0 and the second gamma operational amplifier OPAn in the light-load state, in the foregoing DFC manner.

Alternatively, it may be learned from the foregoing descriptions that in a display process of the electronic device 01, in the N gamma operational amplifiers (OPA0, OPA1, . . . , and OPAn), the first gamma operational amplifier OPA0 and the second gamma operational amplifier OPAn are prone to be in the heavy-load state. Based on this, in some other embodiments of this application, as shown in FIG. 7E, to separately compensate the thrust and the stability of the first gamma operational amplifier OPA0 and the second gamma operational amplifier OPAn, the display driver circuit 200 may include two dynamic bias generators: a first dynamic bias generator 222a and a second dynamic bias generator 222b. In this case, the at least one bias control signal generated by the bias controller 221 may include a first bias control signal CSB1 and a second bias control signal CSB2.

The first dynamic bias generator 222a is electrically connected to the first gamma operational amplifier OPA0. The first dynamic bias generator 222a is configured to output a first bias voltage VB1 based on the first bias control signal CSB1. In this way, the thrust and the stability of the first gamma operational amplifier OPA0 can be compensated when the first gamma operational amplifier OPA0 is in the heavy-load state, and power consumption of the first gamma operational amplifier OPA0 can be reduced in the light-load state, in the foregoing DFC manner through the first dynamic bias generator 222a.

In addition, the second dynamic bias generator 222b is electrically connected to the second gamma operational amplifier OPAn. The second dynamic bias generator 222b is configured to output a second bias voltage VB2 based on the second bias control signal CSB2. Similarly, the thrust and the stability of the second gamma operational amplifierOPAn can be compensated when the second gamma operational amplifier OPAn is in the heavy-load state, and power consumption of the second gamma operational amplifier OPAn can be reduced in the light-load state, in the foregoing DFC manner through the second dynamic bias generator 222b.

It should be noted that in the foregoing descriptions, thrust and stability of the gamma operational amplifier are compensated in the heavy-load state, and power consumption of the gamma operational amplifier is reduced in the light-load state, in the DFC manner by using an example in which at least one of the first gamma operational amplifier OPA0 and the second gamma operational amplifier OPAn in the N gamma operational amplifiers (OPA0, OPA1, . . . , and OPAn) is electrically connected to the dynamic bias generator 222. Based on this, in some embodiments of this application, the display driver circuit 200 may further include a static bias generator 2222 shown in FIG. 7E. The static bias generator 2222 is configured to output a constant bias voltage VB0. In this case, a third gamma operational amplifier (OPA1, OPA2, . . . , or OPAn-1) other than the first gamma operational amplifier OPA0 and the second gamma operational amplifier OPAn in the plurality of gamma operational amplifiers (OPA0, OPA1, . . . , and OPAn) rarely experiences the foregoing extreme heavy-load or extreme light-load condition. Therefore, the third gamma operational amplifier (OPA1, OPA2, . . . , or OPAn-1) may be connected to the static bias generator 2222, and the static bias generator 2222 can provide a constant bias voltage VB0 to the third gamma operational amplifier (OPA1, OPA2, . . . , or OPAn-1), to simplify the circuit.

In some other embodiments of this application, any one of the N gamma operational amplifiers (OPA0, OPA1, . . . , and OPAn) may be electrically connected to the dynamic bias generator 222. Alternatively, in some other embodiments of this application, all of the N gamma operational amplifiers (OPA0, OPA1, . . . , and OPAn) may be electrically connected to the dynamic bias generator 222. A process of compensating thrust and stability of the gamma operational amplifier in the heavy-load state, and reducing power consumption of the gamma operational amplifier in the light-load state, in the DFC manner, is the same as that described above. Details are not described herein.

It may be learned from the foregoing descriptions that the bias controller 221 can obtain a load status of the gamma operational amplifier electrically connected to the dynamic bias generator 222, and control, based on the load status, the dynamic bias generator 222 to adjust the bias voltage of the gamma operational amplifier. The following describes a structure of the bias controller 221 by using an example.

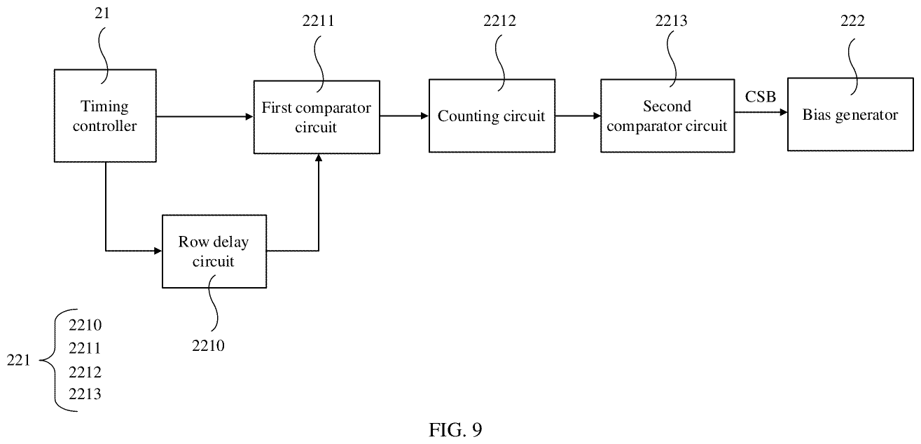

In some embodiments of this application, as shown in FIG. 9, the bias controller 221 may include a row delay circuit 2210, a first comparator circuit 2211, a counting circuit 2212, and a second comparator circuit 2213. The row delay circuit 2210 may be electrically connected to the timing controller 21. The first comparator circuit 2211 is electrically connected to the row delay circuit 2210 and the timing controller 21. The counting circuit 2212 is electrically connected to the first comparator circuit 2211, and the second comparator circuit 2213 is electrically connected to the counting circuit 2212.

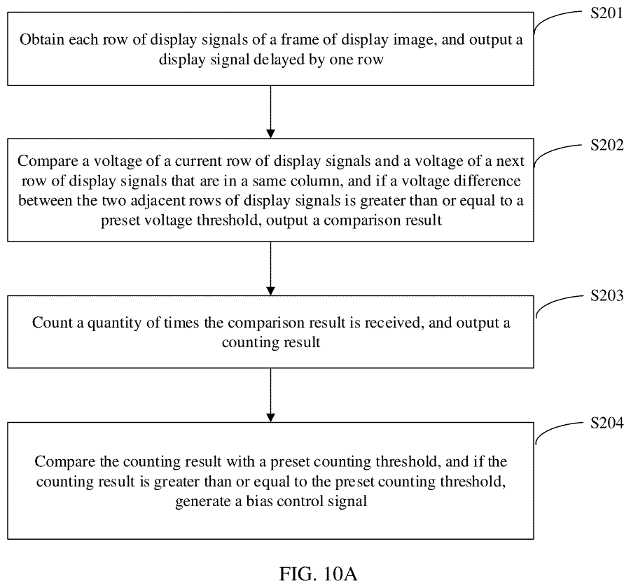

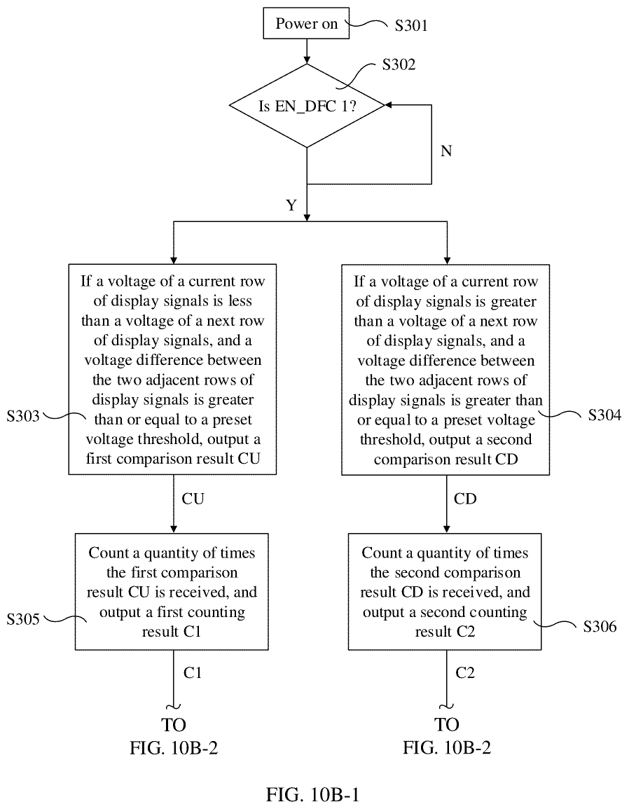

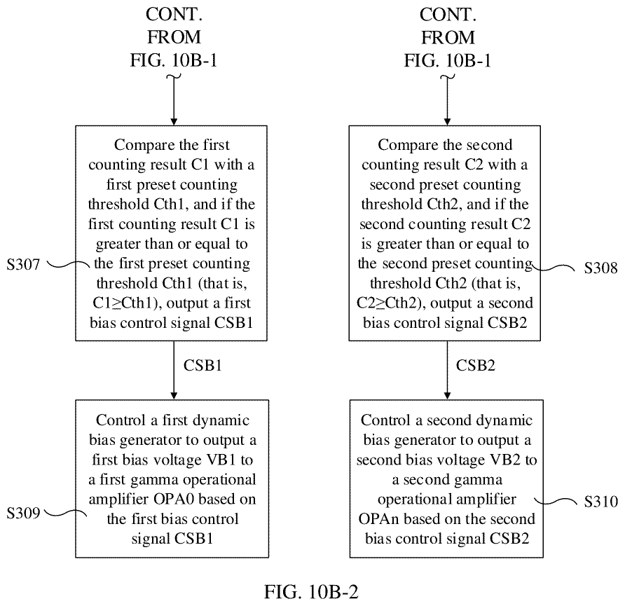

Based on the structure of the bias controller 221 shown in FIG. 9, a specific process in which the bias controller 221 performs S101 may include steps S201 and S202 shown in FIG. 10A. That is, a process in which the bias controller 221 calculates the voltage difference ΔV between the two adjacent rows of display signals Disp in the same column based on the display signal Disp, and if the voltage difference ΔV is greater than or equal to the preset voltage threshold Vth (that is, ΔV≥Vth), performs counting, and outputs the at least one bias control signal CSB based on the counting result includes:

S201: Obtain each row of display signals of a frame of display image, and output a display signal delayed by one row.

Specifically, the row delay circuit 2210 shown in FIG. 9 may perform S201. The row delay circuit 2210 may obtain each row of display signals of a frame of display image from the timing controller 21, and output a display signal delayed by one row. For example, the display signal output by the row delay circuit 2210 is a next row of display signals instead of a current row of display signals.

S202: Compare a voltage of a current row of display signals and a voltage of a next row of display signals that are in a same column, and if a voltage difference between the two adjacent rows of display signals is greater than or equal to the preset voltage threshold, output a comparison result.

Specifically, the first comparator circuit 2211 shown in FIG. 9 may perform S202. The first comparator circuit 2211 receives a current row of display signals of a frame of display image from the timing controller 21 in a same column, compares a voltage of the current row of display signals and a voltage of a next row of display signals of a display image from the row delay circuit 2210, and if a voltage difference ΔV between the two adjacent rows of display signals is greater than or equal to the preset voltage threshold Vth (that is, ΔV≥Vth), outputs a comparison result.

The current row of display signals and the next row of display signals that are used by the first comparator circuit 2211 for comparison belong to the same column, that is, both the current row of display signals and the next row of display signals are output by a same source driving channel 230. For example, a grayscale of a current row of display signals output by a source driving channel 230 may be a minimum grayscale, for example, a grayscale of 0 (a black picture), and a voltage of the current row of display signals may be 8 V (within a range of 6 V to 8 V). A grayscale of a next row of display signals output by the source driving channel 230 may be a maximum grayscale, for example, a grayscale of 255 (a white picture), and a voltage of the next row of display signals may be 0.2 V (within a range of 0.2 V to 2.5 V).

The first comparator circuit 2211 compares the voltage 8 V of the current row of display signals and the voltage 0.2 V of the next row of display signals, and if it is learned that a voltage difference ΔV (8 V−0.2 V=7.8 V) between the two adjacent rows of display signals is greater than or equal to the preset voltage threshold Vth, for example, Vth=6 V (that is, 7.8 V>6 V), outputs a comparison result. For example, the comparison result may be 1 or 0. In this way, it may be learned, through the first comparator circuit 2211, that a swing of the voltage difference ΔV between the two adjacent rows of display signals output by the source driving channel 230 is large.

S203: Count a quantity of times the comparison result is received, and output a counting result.

Specifically, the counting circuit 2212 shown in FIG. 9 may perform S203. The counting circuit 2212 may count a quantity of times of a counting result (0 or 1) from the first comparator circuit 2211, and therefore may obtain a quantity of source driving channels 230 that are in the display driver circuit 200 and for which a voltage difference ΔV between two adjacent rows of output display signals is greater than or equal to the preset voltage threshold Vth, and use the quantity as the counting result.

For example, as shown in FIG. 7A, when all subpixels in a current row display a black picture, and all subpixels in a next row display a white picture, a voltage difference ΔV between two adjacent rows of display signals output by each of the J (for example, J=2560) source driving channels 230 is 7.8 V. In this case, the counting result output by the counting circuit 2212 is 2560 times.

S204: Compare the counting result with the preset counting threshold, and if the counting result is greater than or equal to the preset counting threshold, generate the bias control signal.

Specifically, the second comparator circuit 2213 shown in FIG. 9 may perform step S204. The second comparator circuit 2213 may compare the counting result from the counting circuit 2212 with the preset counting threshold Cth. For example, when the preset counting threshold Cth is 500, and the counting result output by the counting circuit 2212 is 2560 times, the counting result is greater than the preset counting threshold Cth.

In this way, the second comparator circuit 2213 may compare the counting result from the counting circuit 2212 with the preset counting threshold Cth, to learn whether a gamma operational amplifier configured to provide a gamma reference voltage to the source driving channel 230 is in a heavy-load state or a light-load state. For example, when the counting result is greater than the preset counting threshold Cth, the source driving channel 230 is in the heavy-load state.

Based on this, the second comparator circuit 2213 outputs the bias voltage control signal CSB to the dynamic bias generator 222. In this way, the dynamic bias generator 222 can provide, based on the bias voltage control signal CSB, the bias voltage VB to the gamma operational amplifier electrically connected to the dynamic bias generator 222.

In conclusion, as shown in FIG. 9, the row delay circuit 2210 in the bias controller 221 may transmit a next row of display signals to the first comparator circuit 2211, so that the first comparator circuit 2211 can compare a voltage of a current row of display signals from the timing controller 21 and a voltage of the next row of display signals, calculate a voltage difference ΔV between the two rows of display signals, and compare the voltage difference ΔV with the preset voltage threshold Vth, to determine whether there is a case of a large voltage change amplitude in the J source driving channels 230. If there is the case of a large voltage change amplitude, the first comparator circuit 2211 outputs a comparison result to the counting circuit 2212, so that the counting circuit 2212 can count a quantity of source driving channels 230 with a large voltage change amplitude in the J source driving channels 230, and transmit a counting result to the second comparator circuit 2213.

Then, after comparing the counting result with the preset counting threshold Cth, the second comparator circuit 2213 may determine whether a gamma operational amplifier configured to provide a gamma reference voltage to the source driving channel 230 is in a heavy-load or light-load state, and output the bias voltage control signal CSB to the dynamic bias generator 222 based on a determining result. When the gamma operational amplifier configured to provide the gamma reference voltage to the source driving channel 230 is in the heavy-load state, the dynamic bias generator 222 may provide a high bias voltage VBto the gamma operational amplifier based on the bias voltage control signal CSB, to ensure that the gamma operational amplifier has good stability and thrust.

In addition, when the gamma operational amplifier configured to provide the gamma reference voltage to the source driving channel 230 is in the light-load state, the dynamic bias generator 222 may provide a low bias voltage VB to the gamma operational amplifier based on the bias voltage control signal CSB, to help reduce power consumption of the gamma operational amplifier.

It should be noted that in some embodiments of this application, the row delay circuit 2210, the first comparator circuit 2211, the counting circuit 2212, and the second comparator circuit 2213 in the bias controller 221 may be respectively disposed in different chips. Alternatively, in some other embodiments of this application, at least two of the row delay circuit 2210, the first comparator circuit 2211, the counting circuit 2212, and the second comparator circuit 2213 may be integrated into a same chip. This is not limited in this application.

Based on this, in some embodiments of this application, it may be learned from the foregoing descriptions that in a display process of the electronic device 01, in the N gamma operational amplifiers (OPA0, OPA1, . . . , and OPAn), a voltage change amplitude between two adjacent rows of display signals output by the first gamma operational amplifier OPA0 and the second gamma operational amplifier OPAn is prone to be large, that is, the first gamma operational amplifier OPA0 and the second gamma operational amplifier OPAn are prone to be in the heavy-load state. Therefore, to separately control bias voltages of the first gamma operational amplifier OPA0 and the second gamma operational amplifier OPAn, the driver circuit 200 includes a first dynamic bias generator 222a and a second dynamic bias generator 222b shown in FIG. 7E.

On this basis, when the bias controller 221 may include the row delay circuit 2210, the first comparator circuit 2211, the counting circuit 2212, and the second comparator circuit 2213, a method in which the bias controller 221 controls the first dynamic bias generator 222a to provide a first bias voltage VB1 to the first gamma operational amplifier OPA0, and controls the second dynamic bias generator 222b to provide a second bias voltage VB2 to the second gamma operational amplifier OPAn may include S301 to S310 shown in FIG. 10B-1 and FIG. 10B-2.

S301: Power on.

The electronic device 01 is in a power-on state.

S302: Determine whether EN_DFC is 1.

Specifically, a physical DFC button may be disposed in the electronic device 01, or a virtual DFC button may be disposed in a display interface. The DFC button is used to enable a DFC function. After a user triggers the DFC button, a DFC enable signal EN_DFC received by a processor may be 1. In this case, the processor enables the DFC function, to compensate the thrust and the stability of the gamma operational amplifier in the heavy-load state, and reduce the power consumption of the gamma operational amplifier in the light-load state, in the DFC manner.

Alternatively, after a user does not trigger the DFC button, a processor cannot receive a DFC enable signal EN_DFC that is 1, and the DFC function is disabled. In this case, a bias voltage VBreceived by the N gamma operational amplifiers (OPA0, OPA1, . . . , and OPAn) may be a constant voltage, and the voltage does not change with a load change of the gamma operational amplifier.

It should be noted that in some other embodiments of this application, step S302 may not need to be performed. After the electronic device 01 is powered on, the DFC function may be directly enabled.

S303: If the voltage of the current row of display signals is less than the voltage of the next row of display signals, and the voltage difference between the two adjacent rows of display signals is greater than or equal to the preset voltage threshold, output a first comparison result CU.

Specifically, a process of performing S202 by the first comparator circuit 2211 in the bias controller 221 shown in FIG. 9 may include S303. For example, if the first comparator circuit 2211 determines that the voltage (for example, 0.2 V) of the current row of display signals is less than the voltage (for example, 8 V) of the next row of display signals, and the voltage difference ΔV (|8 V−0.2 V|=7.8 V) between the two adjacent rows of display signals is greater than or equal to the preset voltage threshold Vth, for example, Vth=6 V, (that is, 7.8 V>6 V), the first comparison result CU is output. The first comparison result CU may be 1 or 0.

S304: If the voltage of the current row of display signals is greater than the voltage of the next row of display signals, and the voltage difference between the two adjacent rows of display signals is greater than or equal to the preset voltage threshold, output a second comparison result CD.

Specifically, a process of performing S202 by the first comparator circuit 2211 in the bias controller 221 shown in FIG. 9 may alternatively include S304. For example, if the first comparator circuit 2211 determines that the voltage (for example, 8 V) of the current row of display signals is greater than the voltage (for example, 0.2 V) of the next row of display signals, and the voltage difference ΔV (|8 V−0.2 V|=7.8 V) between the two adjacent rows of display signals is greater than or equal to the preset voltage threshold Vth, for example, Vth-6 V, (that is, 7.8 V>6 V), the second comparison result CD is output. The second comparison result CD may be 0 or 1.

S305: Count a quantity of times the first comparison result CU is received, and output a first counting result C1.

Specifically, a process of performing S203 by the counting circuit 2212 in the bias controller 221 shown in FIG. 9 may include S305. For example, the counting circuit 2212 counts the quantity of times of the first comparison result CU from the first comparator circuit 2211, and outputs the first counting result C1. In this way, the counting circuit 2212 obtains a quantity of source driving channels 230 that are in the display driver circuit 200 and for which a voltage of a next row of output display signals is increased (up) relative to a voltage of a current row of display signals and a voltage difference ΔV indicating an increase is greater than or equal to the preset voltage threshold Vth, and uses the quantity as the first counting result C1.

S306: Count a quantity of times the second comparison result CD is received, and output a second counting result C2.

Specifically, a process of performing S203 by the counting circuit 2212 in the bias controller 221 shown in FIG. 9 may alternatively include S306. For example, the counting circuit 2212 counts the quantity of times of the second comparison result CD from the first comparator circuit 2211, and outputs the second counting result C2. In this way, the counting circuit 2212 obtains a quantity of source driving channels 230 that are in the display driver circuit 200 and for which a voltage of a next row of output display signals is decreased (down) relative to a voltage of a current row of display signals and a voltage difference ΔV indicating a decrease is greater than or equal to the preset voltage threshold Vth, and uses the quantity as the second counting result C2.

S307: Compare the first counting result C1 with a first preset counting threshold Cth1, and if the first counting result C1 is greater than or equal to the first preset counting threshold Cth1 (that is, C1≥Cth1), output a first bias control signal CSB1.

Specifically, a process of performing S204 by the second comparator circuit 2213 in the bias controller 221 shown in FIG. 9 may include S307. For example, the second comparator circuit 2213 may compare the first counting result C1 from the counting circuit 2212 with the preset counting threshold Cth. For example, when the preset counting threshold Cth is 2560, and the first counting result C1 output by the counting circuit 2212 is 2560 times, the first bias control signal CSB1 is output.

S308: Compare the second counting result C2 with a second preset counting threshold Cth2, and if the second counting result C2 is greater than or equal to the second preset counting threshold Cth2 (that is, C2≥Cth2), output a second bias control signal CSB2.

Specifically, a process of performing S204 by the second comparator circuit 2213 in the bias controller 221 shown in FIG. 9 may alternatively include S308. For example, the second comparator circuit 2213 may compare the second counting result C2 from the counting circuit 2212 with the preset counting threshold Cth. For example, when the preset counting threshold Cth is 2560, and the second counting result C2 output by the counting circuit 2212 is 2560 times, the second bias control signal is output.

S309: Control the first dynamic bias generator to output the first bias voltage VB1 to the first gamma operational amplifier OPA0 based on the first bias control signal CSB1.

Specifically, the first dynamic bias generator 222a shown in FIG. 7E outputs, under control of the first bias control signal CSB1 from the bias controller 221, the first bias voltage VB1 to the first gamma operational amplifier OPA0 electrically connected to the first dynamic bias generator 222a, so that the first gamma operational amplifier OPA0 in the heavy-load state has good thrust and stability, to implement DFC.

S310: Control the second dynamic bias generator to output the second bias voltage VB2 to the second gamma operational amplifier OPAn based on the second bias control signal CSB2.

Specifically, the second dynamic bias generator 222b shown in FIG. 7E outputs, under control of the second bias control signal CSB2 from the bias controller 221, the second bias voltage VB2 to the second gamma operational amplifier OPAn electrically connected to the second dynamic bias generator 222b, so that the second gamma operational amplifier OPAn in the heavy-load state has good thrust and stability, to implement DFC.

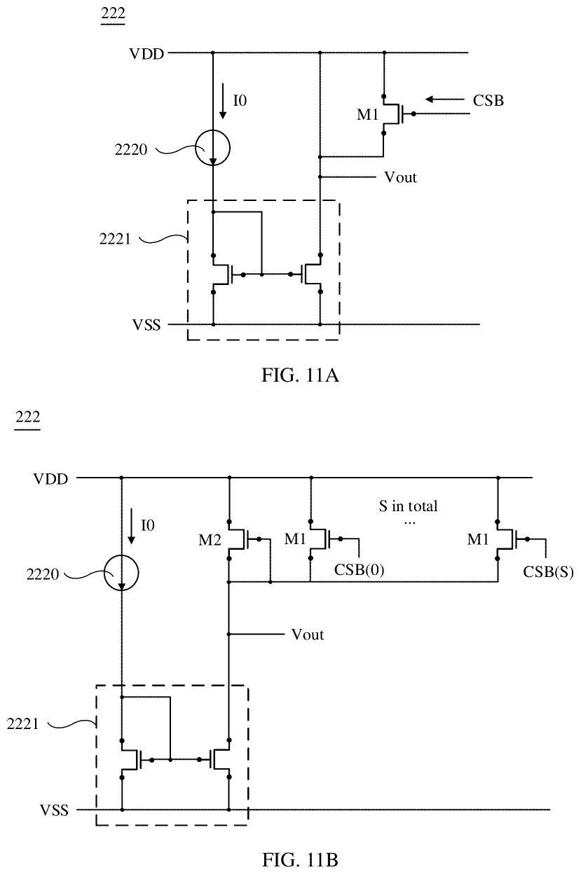

Based on this, to enable the dynamic bias generator 222 to provide, based on the bias voltage control signal CSB, an adjustable bias voltage VBto the gamma operational amplifier, for example, the first gamma operational amplifier OPA0 shown in FIG. 7A or the N^{th} gamma operational amplifier OPAn shown in FIG. 7C, electrically connected to the dynamic bias generator 222, the dynamic bias generator 222 may include a current source 2220, a current mirror 2221, and at least one first switching device M1 shown in FIG. 11A.

The current source 2220 is electrically connected between a first voltage terminal and a second voltage terminal, and is configured to provide an initial current I0. The first voltage terminal is configured to provide a first working voltage VDD, and the second voltage terminal is configured to provide a second working voltage VSS. The current mirror 2221 is electrically connected to the current source 2220, the first voltage terminal, and the second voltage terminal. The current source 2220 can provide a constant initial current I0 to the current mirror 2221.

In addition, a control terminal of the first switching device M1 may be electrically connected to the second comparator circuit 2213 shown in FIG. 9. A first terminal (for example, a source or a drain) of the first switching device M1 is electrically connected to the first voltage terminal (receiving the first working voltage VDD), and a second terminal (for example, the drain or the source) of the first switching device M1 is electrically connected to the current mirror 2221. In addition, the second terminal of the first switching device M1 may be further electrically connected to at least one of the N gamma operational amplifiers (OPA0, OPA1, . . . , and OPAn) through an output terminal Vout. The first switching device M1 is configured to be turned on or turned off under control of the bias control signal CSB output by the bias controller 221. In this case, the current mirror 2221 may mirror the initial current I0 provided by the current source 2220 to a branch in which the first switching device M1 is located. For example, when the bias controller 221 determines that a gamma operational amplifier, for example, OPA0, is in the light-load state, the bias control signal CSB output by the bias controller 221 to the first switching device M1 may control the first switching device M1 to be in an on state. For example, when the first switching device M1 is a P-type transistor, the bias control signal CSB may be 0. Alternatively, when the first switching device M1 is an N-type transistor, the bias control signal CSB may be 1.

When the first switching device M1 is turned on, a resistor of the first switching device M1 is connected in parallel to a resistor of a conducting wire electrically connected between the first voltage terminal (receiving the first working voltage VDD) and the output terminal Vout, so that a voltage output by the output terminal Vout increases. The output terminal Vout is electrically connected to a control terminal of a transistor T1 (as shown in FIG. 6) that is at an input stage of the gamma operational amplifier, for example, OPA0, and that is configured to form a first current source, and the transistor T1 is a P-type transistor. Therefore, a bias voltage (the bias voltage VB output by the dynamic bias generator 222) received by the control terminal of the transistor T1 is high, so that a low bias current I1 flows through the transistor T1. In this way, the gamma operational amplifier, for example, OPA0, in the light-load state performs an operational amplification process under action of a low bias current IB. Therefore, power consumption of the gamma operational amplifier can be reduced.

Alternatively, for another example, when the bias controller 221 determines that a gamma operational amplifier, for example, OPA0, is in the heavy-load state, the bias control signal CSB output by the bias controller 221 to the first switching device M1 may control the first switching device M1 to be in an off state. For example, when the first switching device M1 is a P-type transistor, the bias control signal CSB may be 1. Alternatively, when the first switching device M1 is an N-type transistor, the bias control signal CSB may be 0.

When the first switching device M1 is turned off, resistance between the first voltage terminal (receiving the first working voltage VDD) and the output terminal Vout increases, so that a voltage output by the output terminal Vout decreases. Therefore, a bias voltage (the bias voltage VB output by the dynamic bias generator 222) received by the control terminal of the transistor T1 shown in FIG. 6 is low, so that a high bias current I1 flows through the transistor T1. In this way, the gamma operational amplifier, for example, OPA0, in the heavy-load state performs an operational amplification process under action of a high bias current IB. Therefore, the gamma operational amplifier can have good stability and thrust.

In some other embodiments of this application, as shown in FIG. 11B, the dynamic bias generator 222 may include a plurality of (for example, S) first switching devices M1, and the plurality of first switching devices M1 may be connected in parallel. Alternatively, in some other embodiments of this application, as shown in FIG. 11B, the dynamic bias generator 222 may include a second switching device M2. The second switching device M2 is connected in parallel to the first switching device M1. A difference lies in that a control terminal of the second switching device M2 is electrically connected to an output terminal Vout of the dynamic bias generator 222. Therefore, the second switching device M2 is a transistor that is always in an on state.

In this case, a working principle is the same as that of the circuit in FIG. 11A, and a difference lies in that the bias control signal CSB from the bias controller 221 may be a digital signal (for example, 2 bits, 6 bits, or 8 bits), and a quantity of bits in the bias control signal CSB is the same as a quantity(S) of first switching devices M1 connected in parallel in the dynamic bias generator 222. Herein, S≥2, and S is an integer.

Based on this, each binary number “0” or “1” in the bias control signal CSB may be used to separately control, through a serial-to-parallel converter, the S first switching devices M1 to be turned on or off, to adjust the voltage (or the output bias current IB) from the output terminal Vout of the dynamic bias generator 222. For example, when the first switching transistor M1 is a P-type transistor, and the bias controller 221 determines that a gamma operational amplifier, for example, OPA0, is in the light-load state, binary numbers of most of bits in the bias control signal CSB output by the bias controller 221 to the first switching device M1 may be “0”, to control most of the first switching devices M1 to be in an on state.

In this way, a large quantity of resistors are connected in parallel between the first voltage end (receiving the first working voltage VDD) and the output terminal Vout, to reduce total resistance between the first voltage terminal (receiving the first working voltage VDD) and the output terminal Vout, so that the output terminal Vout of the dynamic bias generator 222 outputs a high voltage. Therefore, the control terminal of the transistor T1 shown in FIG. 6 receives a high voltage, so that a low bias current I1 flows through the transistor T1, to reduce power consumption of the gamma operational amplifier.

Similarly, for another example, when the first switching transistor M1 is a P-type transistor, and the bias controller 221 determines that a gamma operational amplifier, for example, OPA0, is in the heavy-load state, binary numbers of most of bits in the bias control signal CSB output by the bias controller 221 to the first switching device M1 may be “1”, to control most of the first switching devices M1 to be in an off state.

In this way, a small quantity of resistors are connected in parallel between the first voltage end (receiving the first working voltage VDD) and the output terminal Vout, to increase total resistance between the first voltage terminal (receiving the first working voltage VDD) and the output terminal Vout, so that the output terminal Vout of the dynamic bias generator 222 outputs a low voltage. Therefore, the control terminal of the transistor T1 shown in FIG. 6 receives a low voltage, so that a high bias current I1 flows through the transistor T1, to improve stability and thrust of the gamma operational amplifier.

Based on this, it may be learned from the foregoing descriptions that to separately compensate the thrust and the stability of the first gamma operational amplifier OPA0 and the second gamma operational amplifier OPAn, the display driver circuit 200 may include the first dynamic bias generator 222a and the second dynamic bias generator 222b shown in FIG. 7E. In this case, a structure of either of the first dynamic bias generator 222a and the second dynamic bias generator 222b may be shown in FIG. 11A or FIG. 11B. A manner of setting either of the first bias control signal CSB1 and the second bias control signal CSB2 may be obtained in a manner similar to the manner of setting the bias control signal CSB in FIG. 11A or FIG. 11B.

In addition, that the first dynamic bias generator 222a is electrically connected to the first gamma operational amplifier OPA0 may mean that an output terminal Vout (as shown in FIG. 11B) of the first dynamic bias generator 222a may be electrically connected to a control terminal of a transistor T1 (as shown in FIG. 6) that is at an input stage of the first gamma operational amplifier OPA0 and that is configured to form a first current source.

Similarly, that the second dynamic bias generator 222b is electrically connected to the second gamma operational amplifier OPAn may mean that an output terminal Vout (as shown in FIG. 11B) of the second dynamic bias generator 222b may be electrically connected to a control terminal of a transistor T1 (as shown in FIG. 6) that is at an input stage of the second gamma operational amplifier OPAn and that is configured to form a first current source. In addition, a generation process of the first bias voltage VB1 generated by the first dynamic bias generator 222a and a generation process of the second bias voltage VB2 generated by the second dynamic bias generator 222b are the same as that described above. Details are not described herein.

It may be learned from the foregoing descriptions that the bias control signal CSB output by the bias controller 221 may be a digital signal (for example, 2 bits, 6 bits, or 8 bits), and the quantity of bits in the bias control signal CSB is the same as the quantity(S) of first switching devices M1 connected in parallel in the dynamic bias generator 222. In this case, a larger quantity(S) of first switching devices M1 connected in parallel in the dynamic bias generator 222 indicates a larger quantity of bits in the bias control signal CSB, and higher accuracy of controlling the bias voltage VB output by the dynamic bias generator 222.

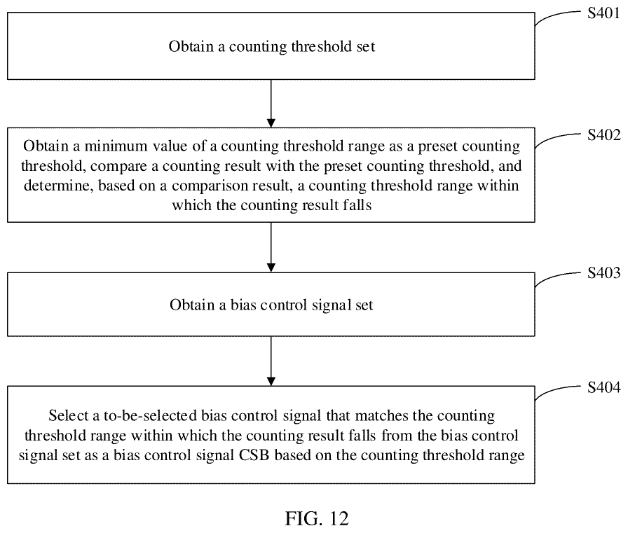

Based on this, when the quantity of first switching devices M1 connected in parallel in the dynamic bias generator 222 is S≥2, a process in which the second comparator circuit 2213 shown in FIG. 9 may perform step S204 may include S401 to S404 shown in FIG. 12.

S401: Obtain a counting threshold set.

Specifically, the counting threshold set may include a plurality of to-be-selected thresholds that increase successively. A counting threshold range is formed between every two adjacent to-be-selected thresholds. For example, if the maximum value of the preset counting threshold is Cth_max=2560, the counting threshold set may include (100, 500, 900, 1200, 1500, 1900, 2300, 2560). Based on this, counting threshold ranges formed by the to-be-selected thresholds in the counting threshold set may be (100-500), (500-900), (900-1200), (1200-1500), (1500-1900), (1900-2300), (2300-2560), and a range greater than 2560.

The counting threshold set may be stored in a memory in the electronic device, and the second comparator circuit 2213 may invoke the counting threshold set from the memory in a process of performing S401. It should be noted that the foregoing descriptions are merely an example for describing a manner of setting the counting threshold set and the maximum value Cth_max of the preset counting threshold, and does not constitute a limitation on the counting threshold set and the maximum value Cth_max of the preset counting threshold.

S402: Obtain a minimum value of the counting threshold range as the preset counting threshold, compare the counting result with the preset counting threshold, and determine, based on a comparison result, a counting threshold range within which the counting result falls.

Specifically, a minimum value of each counting threshold range may be used as the preset counting threshold, that is, each to-be-selected threshold in the counting threshold set (100, 500, 900, 1200, 1500, 1900, 2300, 2560) may be used as the preset counting threshold. Based on this, the counting result from the counting circuit 2212 (as shown in FIG. 9) may be compared with the plurality of preset counting thresholds one by one, to determine, based on the comparison result, the counting threshold range within which the counting result falls.

For example, when the counting result from the counting circuit 2212 (as shown in FIG. 9) is 500, the counting result is equal to the preset counting threshold 500, and therefore the counting result 500 falls within the counting threshold range of (500-900). For another example, when the counting result from the counting circuit 2212 (as shown in FIG. 9) is 2400, the counting result is greater than the preset counting threshold 2300, and therefore the counting result 2400 falls within the counting threshold range of (2300-2560). For another example, when the counting result from the counting circuit 2212 (as shown in FIG. 9) is 3000, the counting result is greater than the preset counting threshold 2560, and therefore the counting result 3000 falls within the counting threshold range greater than 2560.

S403: Obtain a bias control signal set.

Specifically, the bias control signal set includes a plurality of different to-be-selected bias control signals (CSB_001, CSB_002, CSB_003 . . . , and CSB_001), and each to-be-selected bias control signal matches one counting threshold range. Therefore, a quantity I of to-be-selected bias control signals may be the same as a quantity of counting threshold ranges. Herein, I≥2, and I is a positive integer.

It may be learned from the foregoing descriptions that the bias control signal CSB from the bias controller 221 may be a digital signal (for example, 2 bits, 6 bits, or 8 bits), and the quantity of bits in the bias control signal CSB is the same as the quantity(S) of first switching devices M1 connected in parallel in the dynamic bias generator 222 shown in FIG. 11B. Therefore, quantities of bits in all the to-be-selected bias control signals in the bias control signal set may be the same, but binary numbers of all bits may be different.

In this way, in the bias control signal set, different to-be-selected bias control signals may be used to control different quantities of first switching devices M1 in the dynamic bias generator 222 to be in an on state, to control the total resistance between the first voltage end (receiving the first working voltage VDD) and the output terminal Vout based on a requirement, and finally accurately control the voltage output by the output terminal Vout of the dynamic bias generator 222 and the bias voltage VB provided to the gamma operational amplifier.

S404: Select a to-be-selected bias control signal that matches the counting threshold range within which the counting result falls from the bias control signal set as the bias control signal CSB based on the counting threshold range.

For example, the to-be-selected bias control signals CSB_001, CSB_002, CSB_003, CSB_004, CSB_005, CSB_006, CSB_007, and CSB_008 in the bias control signal set may be sequentially in a one-to-one correspondence with the eight counting threshold ranges (100-500), (500-900), (900-1200), (1200-1500), (1500-1900), (1900-2300), (2300-2560), and the range greater than 2560.

The eight counting threshold ranges increase successively. Therefore, quantities of first switching devices M1 that can be turned on by using the to-be-selected bias control signals CSB_001, CSB_002, CSB_003, CSB_004, CSB_005, CSB_006, CSB_007, and CSB_008 in the dynamic bias generator 222 can decrease successively, so that voltages output by the output terminal Vout of the dynamic bias generator 222 under control of the bias voltage control signals decrease successively, and bias voltages VB received by the input stage of the gamma operational amplifier increase successively, to improve the stability and the thrust of the gamma operational amplifier stage by stage.

In conclusion, a plurality of preset counting thresholds Cth are set, so that bias control signals CSB that match different preset counting thresholds Cth can be selected based on the preset counting thresholds Cth. In this way, in the dynamic bias generator 222 controlled by using different bias control signals CSB, different quantities of a plurality of first switching devices M1 are turned on and off, so that the dynamic bias generator 222 can output a plurality of bias voltages VB that match the different bias control signals CSB, to finally improve accuracy of controlling the bias voltage VB.

This application provides a computer-readable storage medium, including computer instructions. When the computer instructions are run on a processor in the foregoing electronic device 01, the processor may be enabled to perform any one of the foregoing control methods.

In addition, this application provides a computer program product, including computer instructions. When the computer instructions are run on a processor in the foregoing first electronic device 01, the processor may be enabled to perform any one of the foregoing control methods.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. A display driver circuit, used in a display module, wherein the display driver circuit comprises:
at least one dynamic bias generator, configured to output a dynamically adjustable bias voltage;
a plurality of gamma operational amplifiers, wherein at least one of the plurality of gamma operational amplifiers is electrically connected to the dynamic bias generator, and the gamma operational amplifier is configured to output a gamma reference voltage based on the bias voltage;
a resistor string, electrically connected to output terminals of the plurality of gamma operational amplifiers, and configured to perform voltage division on output terminals of two adjacent gamma operational amplifiers; and
a plurality of source driving channels, electrically connected to the resistor string.

2. The display driver circuit according to claim 1, wherein
the plurality of gamma operational amplifiers comprise a first gamma operational amplifier and a second gamma operational amplifier, the first gamma operational amplifier outputs an upper-limit gamma reference voltage Vg0, and the second gamma operational amplifier outputs a lower-limit gamma reference voltage Vgn; and
the dynamic bias generator is electrically connected to at least one of the first gamma operational amplifier and the second gamma operational amplifier.

3. The display driver circuit according to claim 2, wherein
the at least one dynamic bias generator comprises:
a first dynamic bias generator, electrically connected to the first gamma operational amplifier; and
a second dynamic bias generator, electrically connected to the second gamma operational amplifier;
the display driver circuit further comprises a static bias generator, configured to output a constant bias voltage; and
the plurality of gamma operational amplifiers comprise at least one third gamma operational amplifier, a gamma reference voltage output by the third gamma operational amplifier is between the lower-limit gamma reference voltage Vgn and the upper-limit gamma reference voltage Vg0, and the static bias generator is electrically connected to the third gamma operational amplifier.

4. The display driver circuit according to claim 1, wherein the display driver circuit further comprises:
a bias controller, electrically connected to the dynamic bias generator, and configured to output a bias control signal, wherein the dynamic bias generator is configured to output the dynamically adjustable bias voltage based on the bias control signal.

5. The display driver circuit according to claim 4, wherein the display driver circuit further comprises:
a timing controller, electrically connected to the bias controller, and configured to generate a display signal, wherein the bias controller is configured to output the bias control signal based on the display signal.

6. The display driver circuit according to claim 1, wherein the dynamic bias generator comprises:
a current source, electrically connected between a first voltage terminal and a second voltage terminal, and configured to provide an initial current;
a current mirror, electrically connected to the current source, the first voltage terminal, and the second voltage terminal; and
at least one first switching device, wherein a control terminal of the first switching device is electrically connected to a second comparator circuit, a first terminal of the first switching device is electrically connected to the first voltage terminal, and a second terminal is electrically connected to the current mirror and an output terminal of the dynamic bias generator.

7. The display driver circuit according to claim 4, wherein
the bias controller comprises:
a row delay circuit, configured to output a display signal delayed by one row;
a first comparator circuit, electrically connected to the row delay circuit, and configured to compare a voltage of a current row of display signals and a voltage of a next row of display signals;
a counting circuit, electrically connected to the first comparator circuit, and configured to count a quantity of times of a comparison result from the first comparator circuit; and
the second comparator circuit, electrically connected to the counting circuit, and configured to: compare a counting result from the counting circuit with a preset counting threshold, and output the bias control signal.

8. A control method for a display driver circuit, wherein the display driver circuit is used in a display module, and comprises at least one dynamic bias generator, a plurality of gamma operational amplifiers, a resistor string, and a plurality of source driving channels, at least one of the plurality of gamma operational amplifiers is electrically connected to the dynamic bias generator, the resistor string is electrically connected to output terminals of the plurality of gamma operational amplifiers, and the source driving channel is electrically connected to the resistor string; and
the control method comprises:
controlling the dynamic bias generator to output a dynamically adjustable bias voltage;
controlling the gamma operational amplifier to output a gamma reference voltage based on the bias voltage; and
controlling the source driving channel to output a voltage.

9. The control method according to claim 8, wherein
before controlling the dynamic bias generator to output the dynamically adjustable bias voltage, the method comprises:
comparing a voltage of a current row of display signals and a voltage of a next row of display signals that are in a same column, and if a voltage difference between the two adjacent rows of display signals is greater than or equal to a preset voltage threshold, outputting a comparison result;
counting a quantity of times the comparison result is received, and outputting a counting result; and
comparing the counting result with a preset counting threshold, and if the counting result is greater than or equal to the preset counting threshold, generating a bias control signal; and
controlling the dynamic bias generator to output the dynamically adjustable bias voltage comprises: controlling the dynamic bias generator to output the dynamically adjustable bias voltage based on the bias control signal.

10. The control method according to claim 9, wherein the at least one dynamic bias generator comprises a first dynamic bias generator and a second dynamic bias generator; the plurality of gamma operational amplifiers comprise a first gamma operational amplifier and a second gamma operational amplifier, the first gamma operational amplifier outputs an upper-limit gamma reference voltage Vg0, and the second gamma operational amplifier outputs a lower-limit gamma reference voltage Vgn; and the first dynamic bias generator is electrically connected to the first gamma operational amplifier, and the second dynamic bias generator is electrically connected to the second gamma operational amplifier;
comparing the voltage of the current row of display signals and the voltage of the next row of display signals that are in the same column, and if the voltage difference between the two adjacent rows of display signals is greater than or equal to the preset voltage threshold, outputting the comparison result comprises:
comparing the voltage of the current row of display signals and the voltage of the next row of display signals that are in the same column; and if the voltage of the current row of display signals is less than the voltage of the next row of display signals, and the voltage difference between the two adjacent rows of display signals is greater than or equal to the preset voltage threshold, outputting a first comparison result; or if the voltage of the current row of display signals is greater than the voltage of the next row of display signals, and the voltage difference between the two adjacent rows of display signals is greater than or equal to the preset voltage threshold, outputting a second comparison result;
counting the quantity of times the comparison result is received, and outputting the counting result comprises: counting a quantity of times the first comparison result is received, and outputting a first counting result; and counting a quantity of times the second comparison result is received, and outputting a second counting result;
comparing the counting result with the preset counting threshold, and if the counting result is greater than or equal to the preset counting threshold, generating the bias control signal comprises:
comparing the first counting result with a first preset counting threshold, and if the first counting result is greater than or equal to the first preset counting threshold, outputting a first bias control signal; and comparing the second counting result with a second preset counting threshold, and if the second counting result is greater than or equal to the second preset counting threshold, outputting a second bias control signal; and
controlling the dynamic bias generator to output the dynamically adjustable bias voltage based on the bias control signal comprises: controlling the first dynamic bias generator to output a first bias voltage to the first gamma operational amplifier based on the first bias control signal; and controlling the second dynamic bias generator to output a second bias voltage to the second gamma operational amplifier based on the second bias control signal.

11. The control method according to claim 9, wherein
comparing the counting result with the preset counting threshold, and if the counting result is greater than or equal to the preset counting threshold, generating the bias control signal comprises:
obtaining a counting threshold set, wherein the counting threshold set comprises a plurality of to-be-selected thresholds that increase successively, and a counting threshold range is formed between every two adjacent to-be-selected thresholds;
obtaining a minimum value of the counting threshold range as the preset counting threshold, comparing the counting result with the preset counting threshold, and determining, based on a comparison result, a counting threshold range within which the counting result falls;
obtaining a bias control signal set, wherein the bias control signal set comprises a plurality of different to-be-selected bias control signals, and each to-be-selected bias control signal matches one counting threshold range; and
selecting a to-be-selected bias control signal that matches the counting threshold range within which the counting result falls from the bias control signal set as the bias control signal based on the counting threshold range.

12. The control method according to claim 9, wherein a maximum value of the preset counting threshold is the same as a quantity of columns of the display signal.
